(19) United States
(12) Patent Application Publication
(10) Pub. No.: US 2010/0180316 A1
(43) Pub. Date: Jul. 15, 2010

(54) BROADCAST DEVICE, RECEIVER, AND BROADCAST METHOD

(75) Inventors: Eiji HASEGAWA, Kawasaki (JP); Hironari SAKAKIHARA, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/685,053

(22) Filed: Jan. 11, 2010

(30) Foreign Application Priority Data
Jan. 15, 2009 (JP) 2009-006791

(51) Int. Cl. H04N 7/173

(52) U.S. Cl. 725/118; 725/134

(57) ABSTRACT

A broadcast method includes specifying an information holding device which holds recorder information for identifying a recorder that receives and records broadcast contents, attaching device information for identifying the information holding device specified by the specifying, to the broadcast contents, and broadcasting the broadcast contents to which the device information is attached.

### CROSS-REFERENCE TO RELATED APPLICATIONS

This application is based upon and claims the benefit of priority of the prior Japanese Patent Application No.2009-6791, filed on Jan. 15, 2009, the entire contents of which are incorporated herein by reference.

### FIELD

The embodiment discussed herein is related to a broadcast device for broadcasting contents, a receiver for receiving contents broadcast from the broadcast device, and a broadcast method for broadcasting contents.

### BACKGROUND

There are recorders for receiving broadcast contents such as TV broadcast contents and recording the received broadcast contents on recording media. Since recording media such as hard disks have increased in storage capacity, it has become possible to store large amounts of broadcast contents of high image quality. Concomitantly, the user can store a large number of broadcast contents cheaply without worrying about the remaining capacity of the recording medium such as a hard disk.

Broadcast services such as TV broadcast services may be affected by weather conditions, and errors may arise in the received broadcast contents. Accordingly, systems free of this problem have been proposed. In particular, broadcast contents are stored in a recorder. If errors are produced in the stored broadcast contents, normal data is received from external equipment through a network and the errors are corrected. Such systems are disclosed in JP-A-2005-065232 and JP-A-2008-160698.

For example, there is a system in which each broadcast content having no error is managed by a given server unit. In this system, if an error occurs in a stored broadcast content, the recorder receives normal data from the server unit and corrects the error in the broadcast content stored in the recorder itself.

Furthermore, there is a method of exchanging data between recorders in a peer-to-peer fashion with each of the recorders storing broadcast contents. In this communications format, if errors occur in broadcast contents stored in one recorder, one recorder receives normal data from another recorder storing normally received broadcast contents and corrects the errors in the broadcast contents stored in it. In this method, a server unit for managing broadcast contents is dispensed with. Consequently, the cost of the server unit can be eliminated.

Where an error occurs in a stored broadcast content in this way, a recorder corrects the error until the broadcast content is played back. Consequently, the user can view and listen to the error-corrected broadcast content.

However, in a system where broadcast contents are managed by a given server unit, the server unit sends normal data to every recorder having stored broadcast contents containing errors. This increases the processing load on the server unit. Also, the cost to run the server unit increases. On the other hand, in the peer-to-peer (P2P) communications format, a server unit for providing uniform management of broadcast contents does not exist and so recorders exchange many messages with each other to thereby seek a device in which a desired broadcast content is stored. As a result, in the P2P communications format, as the number of installed recorders increases, the load on the network through which messages are exchanged between the recorders is increased.

### SUMMARY

According to an aspect of the embodiment, a broadcast method includes specifying an information holding device which holds recorder information for identifying recorders that receive and record broadcast contents, attaching device information for identifying the information holding device specified by the specifying to the broadcast contents, and broadcasting the broadcast contents to which the device information is attached.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram depicting an example of a configuration of a broadcast system according to Embodiment 1;

FIG. 2 is a block diagram illustrating an example of a configuration of one broadcast device according to Embodiment 1;

FIGS. 3A and 3B are schematic diagrams illustrating the storage details of a manager node information table and a broadcast information table;

FIG. 4 is a block diagram illustrating an example of a configuration of a receiver according to Embodiment 1;

FIG. 5 is a table illustrating the storage details of a manager node list;

FIG. 6 is a table illustrating the storage details of an interesting nodes list;

FIG. 7 is a functional block diagram illustrating an example of a functional configuration of broadcast equipment according to Embodiment 1;

FIG. 8 is a schematic diagram illustrating an example of a configuration of broadcast data;

FIG. 9 is a functional block diagram illustrating examples of a functional configuration of a receiver according to Embodiment 1;

FIG. 10 is a flowchart illustrating a procedure for processing performed to assign manager nodes according to Embodiment 1;

FIG. 11 is a flowchart illustrating a procedure for broadcasting according to Embodiment 1;

FIG. 12 is a flowchart illustrating a procedure for recording according to Embodiment 1;

FIG. 13 is a flowchart illustrating a procedure for the recording according to Embodiment 1;

FIG. 14 is a block diagram illustrating an example of a configuration of one broadcast device according to Embodiment 2;

FIG. 15 is a functional block diagram illustrating an example of a functional configuration of one broadcast device according to Embodiment 2;

FIG. 16 is a flowchart illustrating a procedure for processing performed to assign manager nodes according to Embodiment 2;

FIG. 17 is a functional block diagram illustrating an example of a functional configuration of one broadcast device according to Embodiment 3;

FIG. 18 is a flowchart illustrating a procedure for processing performed to assign manager nodes according to Embodiment 3;

FIGS. 19A and 19B are schematic diagrams illustrating the storage details of a manager node information table and a manager node list, respectively, according to Embodiment 4;

FIG. 20 is a functional block diagram illustrating an example of a functional configuration of a receiver according to Embodiment 4;

FIG. 21 is a flowchart illustrating a procedure for recording according to Embodiment 4;

FIG. 22 is a flowchart illustrating a procedure for the recording according to Embodiment 4;

FIG. 23 is a functional block diagram illustrating an example of a functional configuration of a manager node device according to Embodiment 5;

FIG. 24 is a schematic diagram illustrating the storage details of a manager node information table according to Embodiment 6;

FIG. 25 is a block diagram illustrating an example of a configuration of a broadcast device according to Embodiment 7; and

FIG. 26 is a block diagram illustrating an example of a configuration of a receiver according to Embodiment 8.

### DESCRIPTION OF EMBODIMENTS

A broadcast device according to the embodiments specifies an information holding device that holds recorder information for identifying recorders that receive and record contents to be broadcast, and attaches, to the broadcast contents, device information for identifying the specified information holding device. The broadcast device according to the embodiments broadcasts the broadcast contents with the attached device information.

The device information that is attached to the contents is used to identify the information holding device that holds the recorder information for identifying the recorder receiving and storing the broadcast contents.

A receiver according to the embodiments receives the device information and the broadcast contents and records the received device information and the received broadcast contents on a recording medium. The device information is used to identify the information holding device that holds the recorder information for identifying the recorder which receives and records the broadcast contents. The receiver according to the embodiments determines whether or not the broadcast contents recorded on the recording medium contain an error. If the receiver determines that there are errors in the broadcast contents, the receiver acquires the recorder information, which identifies recorders that have recorded the same broadcast contents as the broadcast contents which have been determined to contain an error, from the information holding device identified by the device information. The receiver according to the embodiments acquires the same broadcast contents as the broadcast contents judged to contain an error from the recorder identified by the acquired recorder information and updates the broadcast contents recorded on the recording medium based on the acquired broadcast contents.

The receiver according to the embodiments receives device information for identifying an information holding device that holds recorder information for identifying recorders receiving and recording the broadcast contents, together with the broadcast contents. If the broadcast contents recorded on the recording medium contain an error, the receiver according to the embodiments acquires information for identifying a recorder in which the same broadcast contents as the broadcast contents judged to contain an error is recorded, from the information holding device identified by the device information received together with the broadcast contents. The receiver according to the embodiments acquires the desired broadcast contents from the recorder identified by the recorder information acquired from the information holding device.

A broadcast system having broadcast devices and receivers associated with the embodiments is hereinafter described with reference to the accompanying drawings.

### EMBODIMENT 1

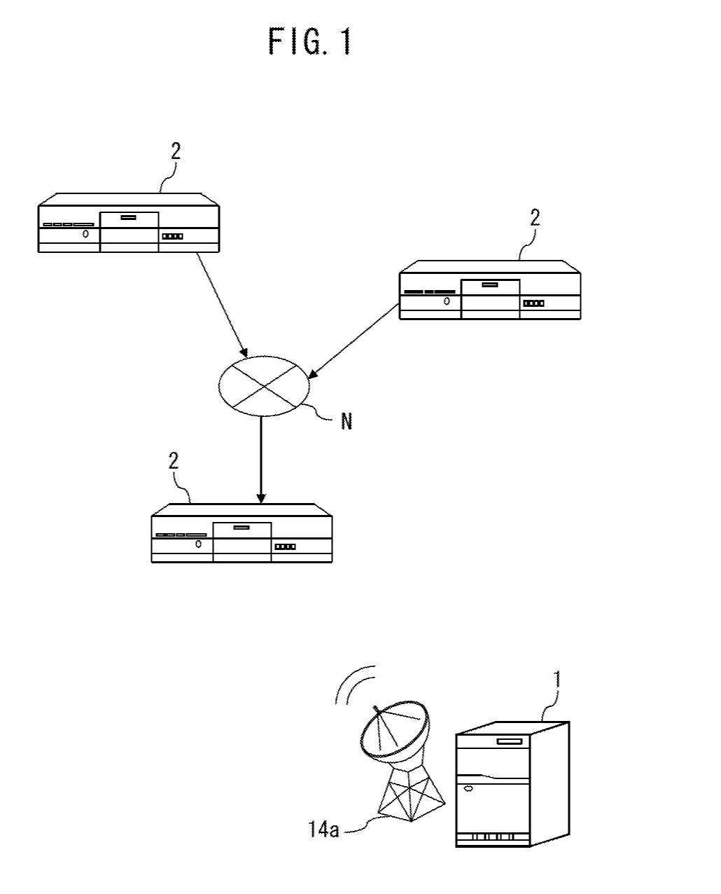

A broadcast system associated with Embodiment 1 is next described. FIG. 1 is a schematic diagram depicting an example of a configuration of the broadcast system according to Embodiment 1. The broadcast system of the present embodiment has a plurality of receivers 2 for receiving broadcast contents that are broadcast by broadcast devices 1 (only one is illustrated) managed by a broadcast station. Each of the receivers 2 is a recorder that receives the broadcast contents and records the broadcast contents on a recording medium. The receivers 2 are interconnected via a network N such as the Internet.

In the broadcast system of Embodiment 1, each broadcast device 1 sends out the broadcast contents via a connected broadcast antenna 14a. Each receiver 2 receives the broadcast contents and records the broadcast contents on a recording medium. The broadcast device 1 may distribute broadcast contents to the receivers 2 via the network N. Each receiver 2 of the present embodiment determines whether or not an error has occurred in the recorded broadcast contents. If there is an error, the receiver receives normal data from another receiver 2 via the network N and makes an error correction.

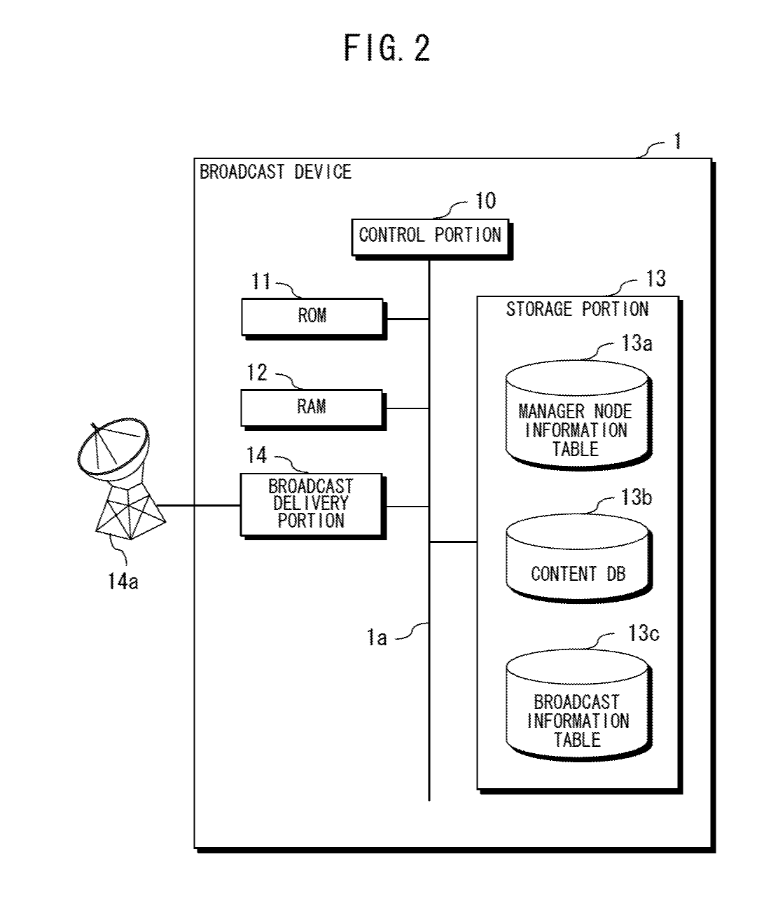

FIG. 2 is a block diagram illustrating an example of a configuration of the broadcast device 1 according to Embodiment 1. For example, the broadcast device 1 of the present embodiment is a well-known server computer. The broadcast device 1 of this embodiment realizes the operation of a broadcast device by causing a computer program disclosed herein to be read by the server computer and by causing the CPU (central processing unit) of the server computer to execute the computer program. The broadcast device disclosed herein may be realized by hardware operating equivalently.

Each broadcast device 1 of the present embodiment has a control portion 10, a ROM (read only memory) 11, a RAM (random access memory) 12, a storage portion 13, and a broadcast delivery portion 14. The hardware portions are interconnected via a bus 1a.

The control portion 10 includes of a CPU, an MPU (microprocessor unit), or the like and reads a control program previously stored in the ROM 11 or storage portion 13 into the RAM 12 and executes the program at a given time. The control portion 10 controls the operation of the hardware portions. Various control programs to operate the server computer as the broadcast device 1 are previously stored in the ROM 11. The RAM 12 is made up of an SRAM or flash memory, for example. Various kinds of data produced when the control program is run by the control portion 10 are temporarily stored in the RAM 12.

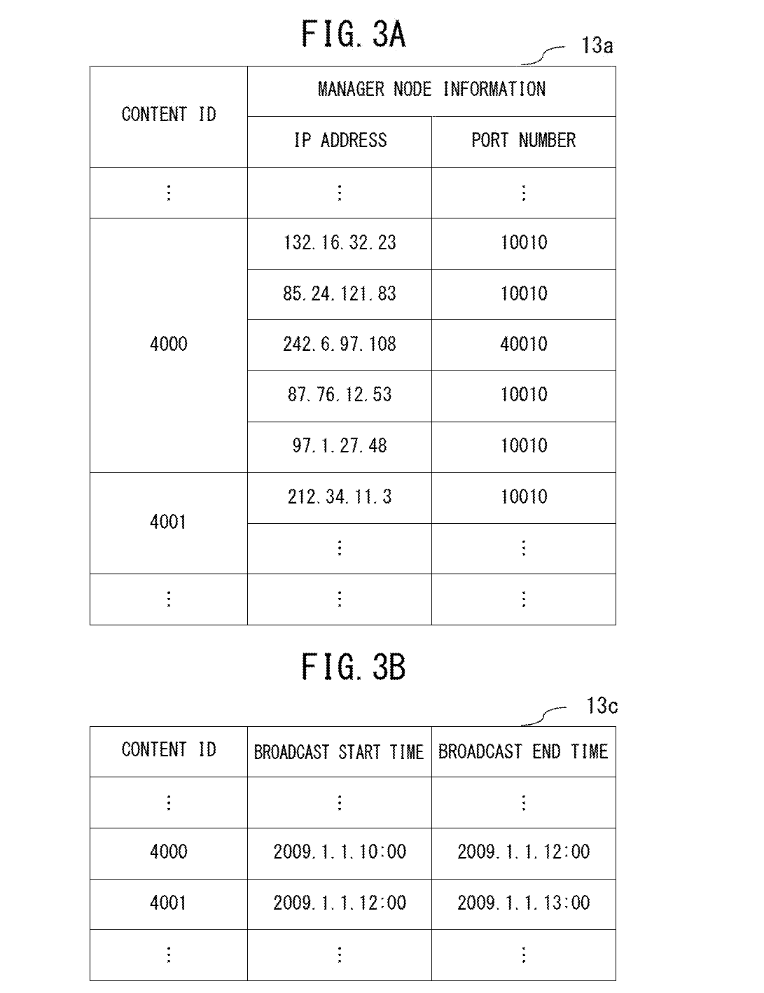

The storage portion 13 is made up of, for example, a hard disk drive or flash memory. Various control programs to operate the server computer as the broadcast device 1 are stored in the storage portion 13. The storage portion 13 stores a manager node information table 13a, a contents database (content DB) 13b as illustrated in FIG. 3A, and a broadcast information table 13c as illustrated in FIG. 3B. Manager node holds recorder information for identifying recorders that receives and records broadcast contents, as information holding device.

Broadcast contents are stored in the content database 13b in association with content IDs assigned to the broadcast contents. For example, each content ID is a value calculated from a program start time, a program end time, a broadcast channel, and/or a program ID. The content ID is information making it possible to uniquely identify the broadcast content.

Broadcast contents include video and audio signals, for example. Broadcast contents also include an EPG (electronic program guide) signal indicating genres of broadcast contents, broadcast channels, program start times, program end times, titles, etc. When broadcast contents involve data broadcasting, the broadcast contents may also include digital signals (digital data). The manager node information table 13a and broadcast information table 13c will be described in detail later.

The broadcast delivery portion 14 illustrated in FIG. 2 is connected with the broadcast antenna 14a. The broadcast delivery portion 14 broadcasts and distributes broadcast contents (broadcast signals) using airwaves of broadcast channels assigned to broadcast stations via the broadcast antenna 14a. The broadcast delivery portion 14 may be fitted with a communication interface connected with the network N. In this case, the broadcast delivery portion 14 may distribute broadcast contents (broadcast signals) to the receivers 2 connected with the network N, via the communication interface.

FIGS. 3A and 3B are schematic diagrams illustrating the storage details of the manager node information table 13a and the broadcast information table 13c. Content IDs for identifying broadcast contents, manager node information indicating manager nodes assigned to individual broadcast contents, and other information is stored in the manager node information table 13a for specific broadcast contents, as illustrated in FIG. 3A. The manager node information is device information for identifying manager nodes that hold information used to identify the receivers 2 that have received and recorded the broadcast contents. Manager node information including IP (Internet protocol) addresses and port numbers of the manager nodes is stored in the manager node information table 13a illustrated in FIG. 3A.

The receivers 2 recording the broadcast contents include receivers 2 having the broadcast contents still recorded therein and receivers 2 in which the broadcast contents were recorded but have now been deleted. In the present embodiment, receivers 2 are referred to as target broadcast contents nodes 2. In the broadcast system of the present embodiment, a manager node may be any one of the receivers 2. In the present embodiment, receivers 2 assigned as manager nodes are referred to as manager nodes 2. Information about the manager nodes 2 is stored as manager node information corresponding to broadcast contents in the manager node information table 13a illustrated in FIG. 3A. At least one or more manager nodes may be assigned to specific broadcast contents. However, the number of manager nodes assigned to specific broadcast contents is not limited.

When the manager nodes are assigned to specific broadcast contents by the control portion 10, storage details in the manager node information table 13a are stored by the control portion 10. The manager node information is used by the receivers 2 to access the manager nodes 2. It is only desirable that the manager node information allow the manager nodes 2 to be uniquely identified on the network N. Accordingly, the manager node information preferably allows for access from the receivers 2 to the manager nodes 2. For example, the manager node information may be a URL (uniform resource locator) character string. For instance, where hash values calculated from IP addresses and port numbers are assigned as node IDs to manager nodes 2, the manager node information may include node IDs.

Content IDs for identifying broadcast contents, start times and end times of each program, etc. are stored for specific broadcast contents in the broadcast information table 13c as illustrated in FIG. 3B. Titles and genres of broadcast contents may be stored in the broadcast information table 13c. When broadcast contents are created and a schedule of broadcasts is determined, storage details of the broadcast information table 13c are stored by the control portion 10.

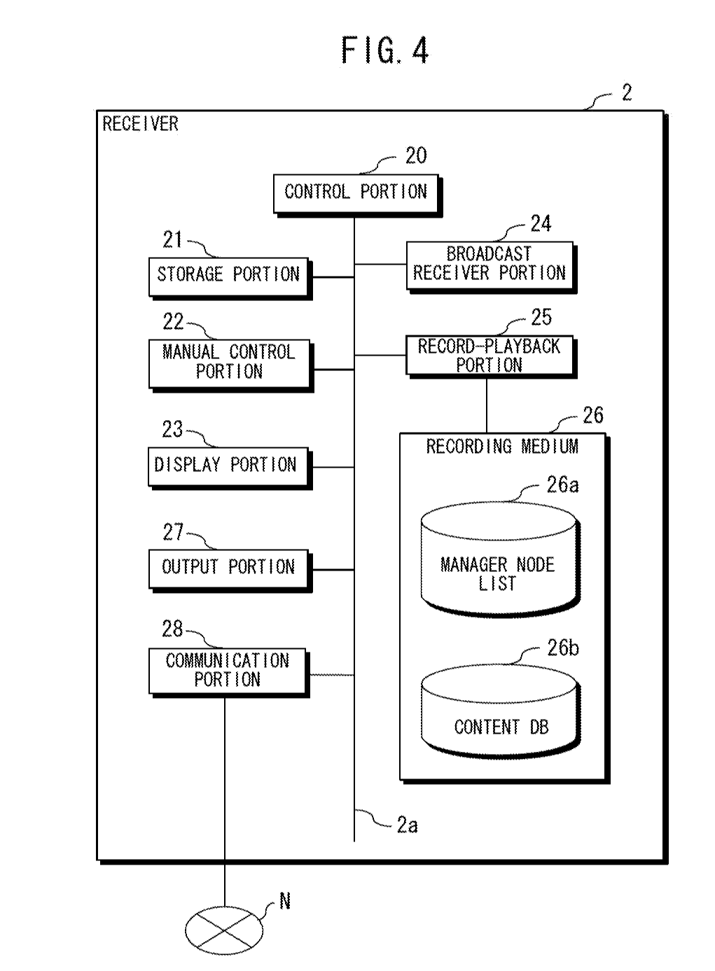

FIG. 4 is a block diagram illustrating an example of a configuration of the receiver 2 according to Embodiment 1. The receiver 2 according to the present embodiment includes, for example, a hard disk recorder using a hard disk as a recording medium. The receiver 2 of the present embodiment realizes the operation of a receiver by causing the hard disk recorder to read a computer program disclosed therein and by causing the CPU of the hard disk recorder to execute the program. The receiver disclosed therein may also be accomplished by hardware operating equivalently.

Each receiver 2 of Embodiment 1 includes a control portion 20, a storage portion 21, a manual control portion 22, a display portion 23, a broadcast receiver portion 24, a record-playback portion 25, an output portion 27, and a communication portion 28. The hardware portions are interconnected via a bus 2a.

The control portion 20 includes a CPU, MPU, or the like, and executes a control program stored in the storage portion 21 at a given time. The control portion 20 controls the operation of the above-described hardware portions. The storage portion 21 includes, for example, a flash memory. Various control programs to operate the receiver 2 are stored in the storage portion 21.

The manual control portion 22 has various keys permitting the user to manipulate the receiver 2. When the keys are manipulated by the user, a control signal corresponding to the manipulated keys is sent to the control portion 20. The control portion 20 carries out various processing operations according to the control signal sent from the manual control portion 22. The manual control portion 22 may include a remote control unit. In this case, the receiver 2 may be remotely controlled using the remote control unit.

The display portion 23 may include, for example, a liquid crystal display. In response to instructions from the control portion 20, various kinds of information (such as information indicating the operative state of the receiver 2, information received via the manual control portion 22, and message information given to the user) are displayed on the display portion 23.

The broadcast receiver portion 24 has a receiver antenna and a tuner (neither of which is illustrated). The broadcast receiver portion 24 receives airwaves of the broadcast channel selected by the user of the receiver 2 via the receiver antenna and acquires a broadcast signal by detecting the received airwaves by the tuner. The acquired broadcast signal is sent from the broadcast receiver portion 24 to the record-playback portion 25 or to the output portion 27. The receiver 2 illustrated in FIG. 4 may receive broadcast contents using the communication portion 28 connected with the network N, the broadcast contents being delivered from the broadcast device 1 via the network N.

The record-playback portion 25 is connected with a recording medium 26, receives the broadcast signal sent from the broadcast receiver portion 24, and records the signal on the recording medium 26. The recording medium 26 is made up of, for example, a hard disk drive. The record-playback portion 25 has an encoder and may encode and compress the broadcast signal into a given format when the signal is recorded on the recording medium 26. MPEG encoding, DV compression, or Motion JPEG encoding may be used as encoding schemes.

The record-playback portion 25 reads the broadcast signal from the recording medium 26 and sends the broadcast signal to the output portion 27. The record-playback portion 25 may have a decoder. If the broadcast signal read from the recording medium 26 has been encoded and compressed, the record-playback portion 25 may decode and decompress the broadcast signal.

When the user makes a reservation for recording broadcast contents via the manual control portion 22, the record-playback portion 25 stores reservation information indicating the details of the reserved recording onto the recording medium 26 or into the storage portion 21. The reservation information includes the broadcast channel of the reserved recording, recording start time (program start time), recording end time (program end time), title of the broadcast content, genre of the content, and the like.

When the user issues an instruction for starting recording via the manual control portion 22 or when the recording start time indicated by the reservation information arrives, the record-playback portion 25 starts to record the broadcast signal acquired by the broadcast receiver portion 24 onto the recording medium 26. When the user issues an instruction to terminate the recording via the manual control portion 22 or when the recording end time indicated by the reservation information arrives, recording of the broadcast signal onto the recording medium 26 is terminated.

The output portion 27 is connected with a TV receiver, for example, via a video signal cable and audio signal cable. The output portion 27 separates the broadcast signal sent from the broadcast receiver portion 24 or a broadcast signal, read from the recording medium 26 by the record-playback portion 25, into a video signal and an audio signal. The output portion 27 outputs the separated video signal to the TV receiver via the video signal cable. The output portion 27 outputs the separated audio signal to the TV receiver via the audio signal cables.

The output portion 27 may be connected with a display device via the video signal cable and connected with loudspeakers via the audio signal cables. In this case, the output portion 27 outputs the video signal separated from the broadcast signal to the display device via the video signal cable, and outputs the audio signal separated from the broadcast signal to the loudspeakers via the audio signal cables.

The receiver 2 may be fabricated integrally with the display portion and loudspeakers. In this case, the output portion 27 outputs the video signal and the audio signal to the display portion and loudspeakers, respectively, mounted in the receiver 2.

The communication portion 28 is a network interface card having an interface for connection with the network N. The communication portion 28 communicates with other receivers 2 via the network N. The communication portion 28 performs P2P packet communications with the other receivers 2 via the network N, for example, based on communications parameters of the other receivers 2. For example, the communications parameters may be IP address and port number assigned to each receiver 2.

In the broadcast system of the present embodiment (Embodiment 1), a broadcast signal broadcast from the broadcast device 1 is a signal carrying the broadcast contents to which manager node information indicating manager nodes assigned to individual broadcast contents are attached. In each receiver 2 of Embodiment 1, the broadcast receiver portion 24 separates the acquired broadcast signal into the broadcast contents and manager node information and sends the broadcast contents and manager node information to the record-playback portion 25. When the broadcast contents and manager node information are sent to the output portion 27, the broadcast receiver portion 24 sends only the broadcast contents separated from the broadcast signal to the output portion 27.

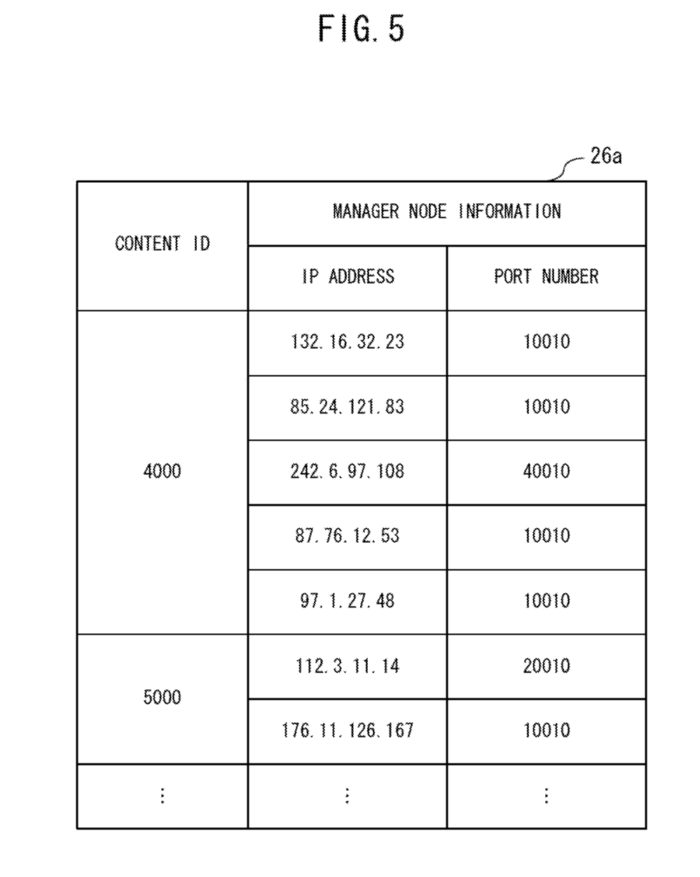

The record-playback portion 25 associates the broadcast contents and manager node information sent from the broadcast receiver portion 24 with each other and records the broadcast contents and manager node information onto the recording medium 26. That is, the recording medium 26 creates and stores a manager node list 26a as illustrated in FIG. 5 and stores the broadcast contents.

FIG. 5 is a table illustrating the storage details of the manager node list 26a. As illustrated in FIG. 5, a content ID for identifying specific incoming broadcast contents and manager node information attached to the broadcast contents are stored for specific broadcast contents in the manager node list 26a. Whenever the record-playback portion 25 records specific broadcast contents sent from the broadcast receiver portion 24 into the contents database 26b, information indicated by the storage details of the manager node list 26a is stored by the record-playback portion 25.

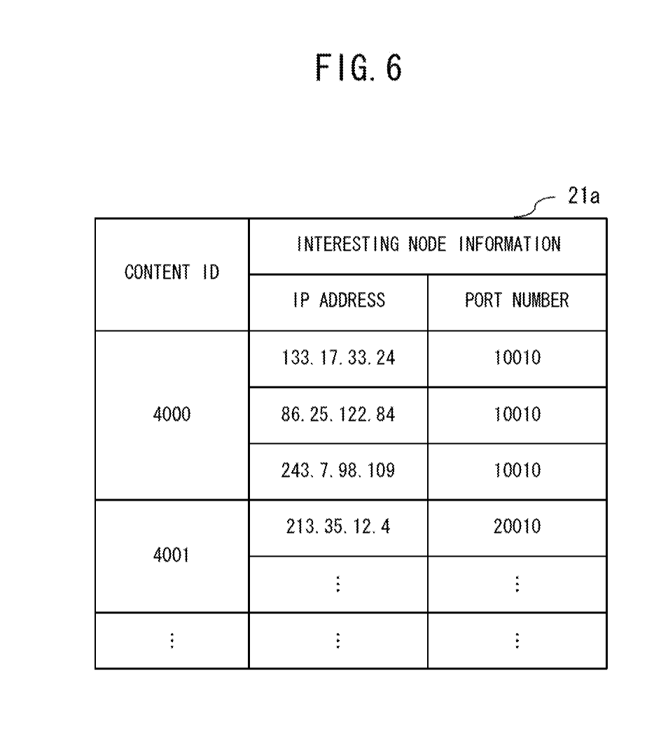

In some cases, each receiver 2 of the present embodiment (Embodiment 1) may operate as the manager node 2. In this case, the control portion 20 of the receiver (manager node) 2 creates an interesting nodes list 21a as illustrated in FIG. 6 and stores the interesting nodes list 21a in the storage portion 21. FIG. 6 is a table illustrating the storage details of the interesting nodes list 21a. As illustrated in FIG. 6, a content ID for identifying specific broadcast contents, interesting node information for identifying receivers 2 (interesting nodes) that recorded various broadcast contents, and other information are stored for specific broadcast contents in the interesting nodes list 21a. In the interesting nodes list 21a illustrated in FIG. 6, IP addresses and port numbers of the interesting nodes 2 are stored as the interesting node information.

Whenever the manager node 2 is informed of completion of recording of contents from each interesting node 2, the interesting nodes list 21a is stored by the control portion 20 of the manager node 2. The interesting nodes 2 may be receivers 2 that recorded broadcast contents which have now been deleted, as well as receivers 2 in which broadcast contents are currently recorded. Whenever the manager node 2 is informed of a start of recording of specific broadcast contents from each interesting node 2, the interesting node information may be stored in the interesting nodes list 21a by the control portion 20 of the manager node 2.

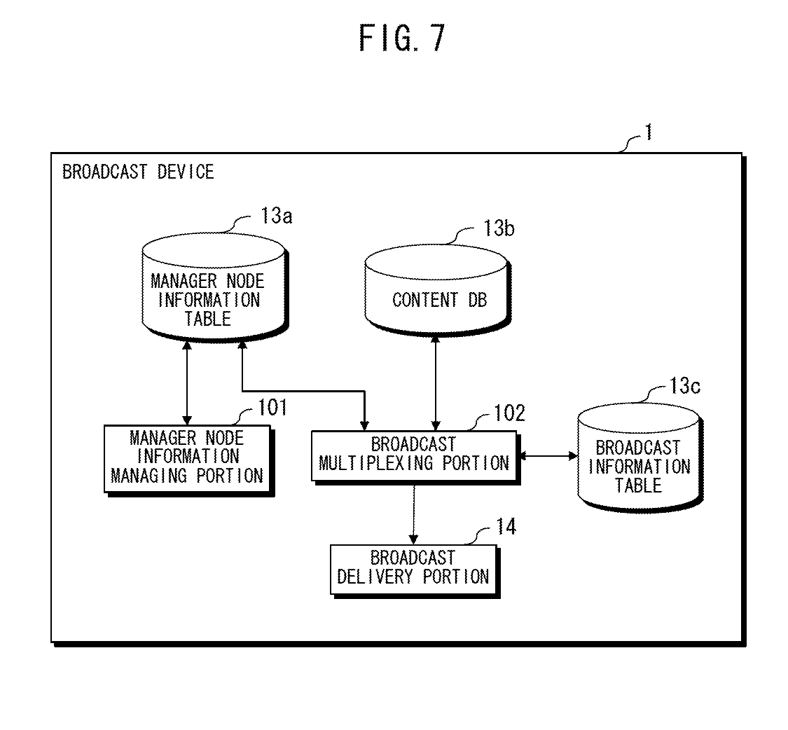

Functions realized by making the control portion 10 of the broadcast device 1 execute the control program stored in the ROM 11 or storage portion 13 in the broadcast system of the present embodiment (Embodiment 1) are described below. FIG. 7 is a functional block diagram illustrating an example of functional configuration of the broadcast device 1 according to Embodiment 1.

In the broadcast device 1 of the present embodiment, the control portion 10 realizes the functions of manager node information managing portion 101, a broadcast multiplexing portion 102, and other parts by executing the control program stored in the ROM 11 or storage portion 13.

In the broadcast system of Embodiment 1, when contents to be broadcast are newly created, the manager node information managing portion 101 of the broadcast device 1 assigns a manager node to the created broadcast contents. The manager node information managing portion 101 of the present embodiment specifies a given number (e.g., five) of receivers 2 from the receivers 2 connected with the network N and assigns the specified receivers as the manager nodes for the broadcast contents.

Where node IDs are assigned to the receivers 2, for example, one method of specifying the receivers 2 assigned as the manager nodes is to specify receivers 2 having node IDs close to the content IDs of the broadcast contents. However, any other method may be used. In another method, the hash values of the content IDs of broadcast contents are compared with the hash values of the node IDs of the receivers 2, and the receivers 2 of node IDs having hash values closer to the hash values of the content IDs may be specified. The number of the receivers 2 assigned as the manager nodes is not limited to five. The number may be at least one.

In the broadcast device 1 of the present Embodiment 1, information (IP address and port number), for example, about the receivers 2 connected with the network N is previously stored in the storage portion 13. The manager node information managing portion 101 reads information about the specified receivers 2 from the storage portion 13 and stores the information in the manager node information table 13a so that the information is associated with the content IDs of the broadcast contents. Consequently, as illustrated in FIG. 3A, the content IDs and information about the manager nodes assigned to the broadcast contents are stored in the manager node information table 13a.

The broadcast multiplexing portion 102 constantly monitors the storage details of the broadcast information table 13c and determines whether there are any broadcast contents to be broadcast. In particular, the broadcast multiplexing portion 102 determines whether or not the program start time of any broadcast contents stored in the broadcast information table 13c will be within a given time from the present time. If the determination is Yes, the broadcast multiplexing portion 102 reads the content ID of the broadcast contents from the broadcast information table 13c.

The broadcast multiplexing portion 102 reads the manager node information, which corresponds to the content ID read from the broadcast information table 13c, from the manager node information table 13a. Furthermore, the broadcast multiplexing portion 102 reads the broadcast contents, which correspond to the content ID read from the broadcast information table 13c, from the content database 13b. The broadcast multiplexing portion 102 multiplexes the broadcast contents read from the content database 13b with the manager node information and content ID read from the manager node information table 13a, thus creating broadcast data. The broadcast multiplexing portion 102 distributes the created broadcast data via the broadcast delivery portion 14.

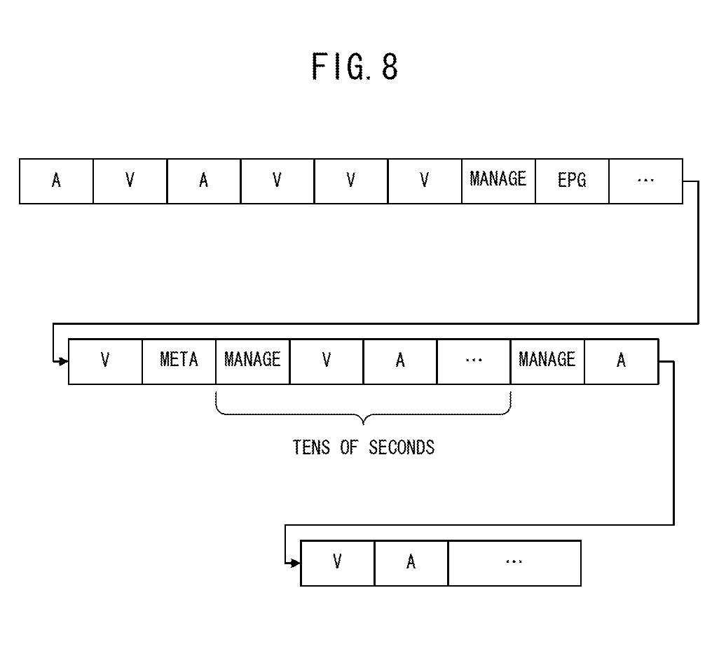

FIG. 8 is a schematic diagram illustrating an example of a configuration of broadcast data. In FIG. 8, “A” indicates an audio signal (speech packets). “V” indicates a video signal (video packets). “Manage” indicates manager node information. In FIG. 8, EPG indicates an EPG signal (EPG packets). “Meta” indicates meta information (meta packets). The meta information indicates the kinds of data of the broadcast contents, and includes information indicating that the data is broadcast contents and/or content IDs.

Therefore, the broadcast contents include audio signals, video signals, EPG signals, and meta information. The broadcast multiplexing portion 102 multiplexes the broadcast contents by interleaving manager node information and content ID, for example, at intervals of 10 to tens of seconds to create broadcast data. Packet IDs are assigned to packets.

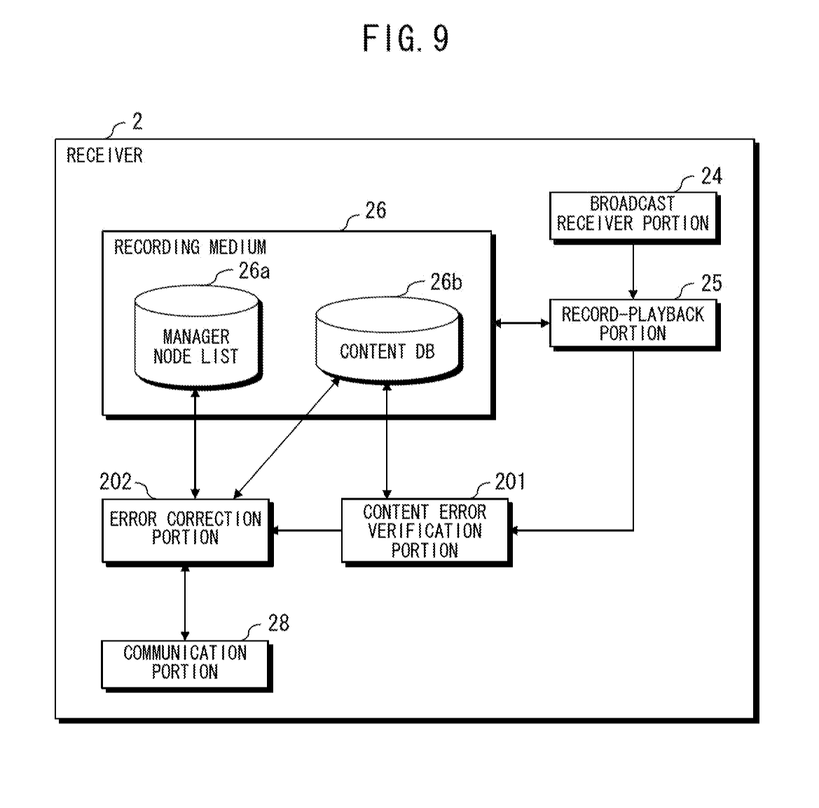

In the broadcast system of the present embodiment (Embodiment 1), functions realized by causing the control portion 20 of the receiver 2 to execute a control program stored in the storage portion 21 are described below. FIG. 9 is a functional block diagram illustrating examples of a functional configuration of each receiver 2 according to Embodiment 1.

In the receiver 2 of Embodiment 1, the control portion 20 executes the control program stored in the storage portion 21, thus realizing the functions of a content error verification portion 201 and an error correction portion 202.

In the broadcast system of the present embodiment (Embodiment 1), the broadcast receiver portion 24 of each receiver 2 acquires the broadcast data created by the broadcast device 1 by multiplexing the broadcast contents with the manager node information as described previously. The broadcast receiver portion 24 separates the acquired broadcast data into the broadcast contents and the manager node information and sends the broadcast contents and manager node information to the record-playback portion 25. The record-playback portion 25 receives the broadcast contents sent from the broadcast receiver portion 24 and records the broadcast contents into the content database 26b on the recording medium 26 in association with the content IDs. Furthermore, the record-playback portion 25 receives manager node information sent from the broadcast receiver portion 24 and records the information into the manager node list 26a on the recording medium 26 in association with the content IDs. When the recording of the broadcast contents into the content database 26b is complete, the record-playback portion 25 informs the content error verification portion 201 that the content IDs of the broadcast contents have been recorded.

When the content error verification portion 201 of the receiver 2 is informed of completion of the recording by the record-playback portion 25, the content error verification portion 201 verifies the broadcast contents stored in the content database 26b in association with the content IDs and determines whether or not there is an error. The content error verification portion 201 detects dropouts (packet losses) of packets, for example, by checking the packet IDs given to the packets. The content error verification portion 201 determines whether the broadcast contents contain errors by calculating a check sum or hash value from the received broadcast signal and comparing the check sum or hash value against a previously attached check sum or forecasted hash value of the broadcast signal.

If the content error verification portion 201 determines that the broadcast contents contain an error, the verification portion identifies the location and/or range of the error. Specific broadcast contents have time stamp values permitting identification of locations within the broadcast contents. The time stamp values provide information making it possible to uniquely identify the locations of a Program Clock Reference (PCR), a Program Time Stamp (PTS), and so on within the broadcast content. Consequently, the content error verification portion 201 identifies the location of an error using the time stamp values, for example “1,000 to 1,200”. The location of an error may also be identified, for example, using a packet ID.

The content error verification portion 201 informs the error correction portion 202 about the result of verification of the broadcast contents together with the content ID. If the broadcast contents are determined to contain an error, the verification portion also informs the error correction portion 202 as to the location of the detected error.

If the error correction portion 202 is informed that the broadcast contents contain no error, the correction portion 202 reads manager node information corresponding to one of the content IDs of which notice has been given by the content error verification portion 201, from the manager node list 26a. The error correction portion 202 informs, via the communication portion 28, the manager node 2 indicated by the manager node information read from the manager node list 26a that the recording of the broadcast contents having the content ID of which notice has been given from the content error verification portion 201 has been completed.

When the manager node 2 is informed that the recording of broadcast contents from the receiver 2 has been completed, the manager node stores interesting node information including the IP address and port number of the receiver 2, which has given the notice, into the interesting nodes list 21a so that the interesting node information is associated with the content ID of which notice has been given. Consequently, as illustrated in FIG. 6, content IDs and interesting node information about specific broadcast contents are stored in the interesting nodes list 21a of the manager node 2. When the manager node 2 is informed of a start of recording of a specific broadcast contents from the receiver 2, the manager node may store the interesting node information including the IP address and port number of the informed receiver 2 in the interesting nodes list 21a so that the interesting node information is associated with the content ID.

If the IP address and port number of the receiver 2 which gives a notice of completion of recording of specific broadcast contents are stored as interesting node information in the interesting nodes list 21a, the manager node 2 returns a message indicating completion of the storage to the receiver 2 that is also an interesting node 2. In consequence, the receiver 2 learns that information about itself has been stored as interesting node information in the manager node 2.

When the receiver 2 informs the manager node 2 of completion or start of recording of broadcast contents, the receiver 2 may not obtain a response from the manager node 2. For example, where the manager node 2 fails to operate normally (e.g., when the power supply of the manager node 2 is down or when there is a fault with the manager node 2), the manager node 2 may not send a response to a message sent from the receiver 2. In this case, the error correction portion 202 of the receiver 2 reads, from the manager node list 26a, different manager node information corresponding to one of the content IDs of which notice is given from the content error verification portion 201. Similarly, the error correction portion 202 informs the manager node 2 indicated by the manager node information read from the manager node list 26a that the recording of a broadcast content having the content ID of which a notice has been given from the content error verification portion 201, has been completed.

The error correction portion 202 of the receiver 2 repeats the above-described operations until the error correction portion 202 receives a response from one of the manager nodes indicated by manager node information corresponding to the content ID of which a notice has been given from the content error verification portion 201. Consequently, receiver 2 can get other interesting nodes information through one of the manager node.

Where the error correction portion 202 reads manager node information from the manager node list 26a, each set of manager node information may be read out in the same order in which the manager node information is stored in the manager node list 26a. Alternatively, the manager node information about a manager node a short network distance away from the receiver 2 having the error correction portion 202 may be read out. Furthermore, the error correction portion 202 may read out manager node information having a node ID close to the node ID assigned as the receiver 2 having the error correction portion 202. Still alternatively, the error correction portion may read out manager node information completely at random.

On the other hand, if the error correction portion 202 is informed of the location of an error in specific broadcast contents, the correction portion reads the manager node information corresponding to the content ID of which notice has been given from the content error verification portion 201 from the manager node list 26a. The error correction portion 202 makes a request, via the communication portion 28, to the manager node 2 indicated by the manager node information read from the manager node list 26a for interesting node information corresponding to the content ID of which notice is given from the content error verification portion 201.

When the manager node 2 is asked for interesting node information from the receiver 2, the manager node 2 reads the requested interesting node information from the interesting nodes list 21a. The manager node 2 sends the interesting node information read from the interesting nodes list 21a to the requesting receiver 2. When the manager node 2 is asked for interesting node information from the receiver 2, if the requesting interesting node information is not stored in the list 21a of nodes of interest, the manager node 2 sends a message to the effect that the manager node 2 does not hold the requested interesting node information to the requesting receiver 2.

If the error correction portion 202 of the receiver 2 does not receive the desired interesting node information from the manager node 2 that was asked to provide the interesting node information (e.g., when the manager node 2 asked to provide the interesting node information does not respond for a given period of time or when the manager node 2 gives notice to the effect that the manager node 2 does not hold the interesting node information), the correction portion 202 reads different manager node information corresponding to the content ID, of which notice is given from the content error verification portion 201, from the manager node list 26a.

The error correction portion 202 similarly makes a request to the manager node 2 indicated by the manager node information read from the manager node list 26a for interesting node information corresponding to the content ID of which notice is given from the content error verification portion 201. The error correction portion 202 repeats the above-described processing operations until desired or pertinent interesting node information is acquired from a manager node 2. Consequently, it may be possible that the receiver 2 acquires the desired interesting node information from a manager node 2.

If the error correction portion 202 acquires the appropriate interesting node information from a manager node 2, the error correction portion 202 stores the acquired interesting node information in the storage portion 21. The error correction portion 202 reads one set of interesting node information from the storage portion 21. The error correction portion 202 makes a request to the interesting node 2 indicated by the interesting node information read from the storage portion 21 for information about the location of an error of which notice has been given from the content error verification portion 201, via the communication portion 28. In particular, the error correction portion 202 informs the interesting node 2 about the content ID of specific broadcast contents having the error and the location of the error, and makes a request for information for correcting the error in the specific broadcast contents.

If information is requested from the receiver 2, the interesting node 2 reads information about the content ID and the location of the error of which notice is given from the receiver 2, from the content database 26b on the recording medium 26. The interesting node 2 sends the information read from the content database 26b to the requesting receiver 2. When the interesting node 2 is asked for information for correcting the error in the broadcast contents from the receiver 2, if the requested information is not stored in the content database 26b, the interesting node 2 notifies the receiver 2 that the interesting node 2 does not hold the requested information.

If the error correction portion 202 of the receiver 2 fails to receive desired information from the interesting node 2 that was asked to provide information for correcting the error (e.g., when the interesting node 2 asked to provide the information for correcting the error does not respond for a given period of time or when the interesting node 2 notifies the receiver 2 that the interesting node 2 does not hold the information), the error correction portion reads different interesting node information stored in the storage portion 21 from the storage portion 21.

The error correction portion 202 similarly makes a request to another interesting node 2 indicated by other interesting node information read from the storage portion 21 for information about the location of error of which notice has been given from the content error verification portion 201. The error correction portion 202 repeats the above-described processing operations until information for correcting the error is acquired from an interesting node indicated by interesting node information contained in the interesting node list obtained from the manager node 2. In consequence, the receiver 2 may reliably acquire the information for correcting the error in the specific broadcast contents.

When the error correction portion 202 acquires information for correcting errors in the broadcast contents from an interesting node 2, the correction portion corrects the errors in the broadcast contents using the acquired information. In particular, in the broadcast contents recorded in the content database 26b, the error correction portion 202 overwrites the location of the error of which notice is given from the content error verification portion 201, with the acquired information.

As described previously, when the broadcast device 1 broadcasts the broadcast contents, manager node information indicating a manager node 2 holding information about an interesting node 2 in which the broadcast contents are recorded is multiplexed with the broadcast contents. Consequently, if the receiver 2 receiving the broadcast contents wants to find an interesting node 2 that has recorded the broadcast contents, the receiver 2 makes an inquiry to the manager node 2 indicated by the manager node information multiplexed with the broadcast contents. Thus, the receiver 2 itself may not search for the interesting node 2 that has recorded the broadcast contents. This reduces communications between the receivers 2, which would otherwise have been required to search for the interesting node 2. As a result, the communication load is reduced.

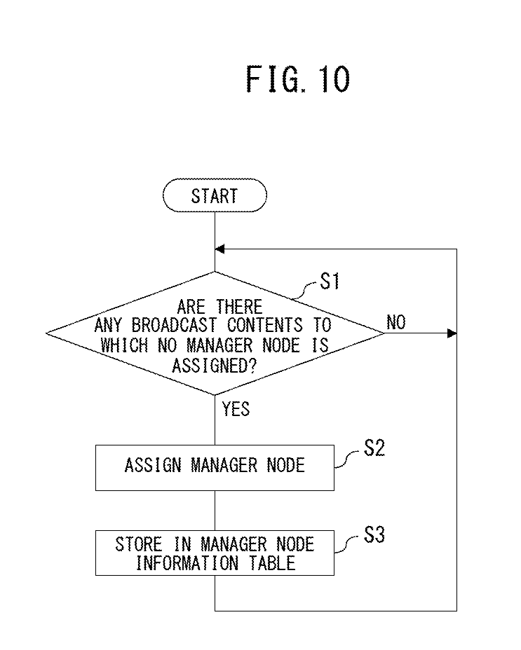

Processing performed by the broadcast system of the present embodiment (Embodiment 1) to assign manager nodes to the broadcast contents by the broadcast device 1 is now described with reference to the flowchart illustrated in FIG. 10. The following processing is performed by the control portion 10 according to a control program stored in the ROM 11 or storage portion 13 of the broadcast device 1.

The control portion 10 of the broadcast device 1 determines whether there are any broadcast contents to which no manager nodes 2 have been assigned yet (S1). If the decision at the step S1 is NO, the control portion 10 enters a wait state. If the decision at the step S1 is YES (i.e., there are broadcast contents to which no manager node 2 has been assigned), the control portion 10 assigns one manager node 2 to the broadcast contents (S2).

The control portion 10 stores the content ID of the broadcast contents and the information (IP address and port number) about the manager node 2 assigned to the broadcast contents into the manager node information table 13a so that the content ID and the information about the manager node 2 are associated with each other (S3). The control portion 10 returns to step S1, where manager nodes 2 are successively assigned to broadcast contents to which no manager nodes 2 are assigned yet.

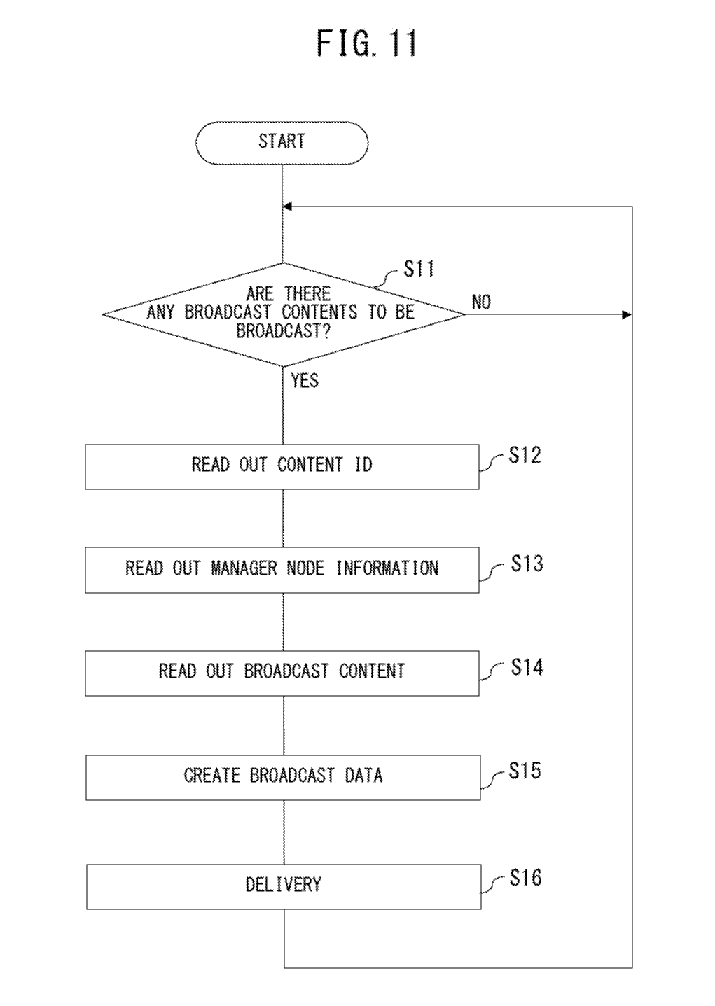

Processing performed by the broadcast device 1 of the present embodiment (Embodiment 1) to broadcast specific broadcast contents is next described with reference to the flowchart of FIG. 11. The following processing is performed by the control portion 10 according to a control program stored in the ROM 11 or storage portion 13 of the broadcast device 1.

The control portion 10 of the broadcast device 1 determines, based on the storage details of the broadcast information table 13c, whether there are any broadcast contents to be broadcast (S11). If the control portion 20 determines that there are no broadcast contents to be broadcast (NO at step S11), the control portion 10 enters a wait state. On the other hand, if the control portion 20 determines that there are broadcast contents to be broadcast (YES at step S11), the control portion 10 reads the content ID of the broadcast contents from the broadcast information table 13c (S12).

The control portion 10 reads the manager node information corresponding to the content ID read out from the manager node information table 13a (S13). The control portion 10 reads out broadcast contents corresponding to the content ID read out from the content database 13b (S14). The control portion 10 multiplexes the read out broadcast contents with the manager node information and the read out content ID to create broadcast data (S15). The control portion 10 delivers the created broadcast data (S16). The control portion 10 returns to step S11, where the above-described processing operations for broadcasting are repeated.

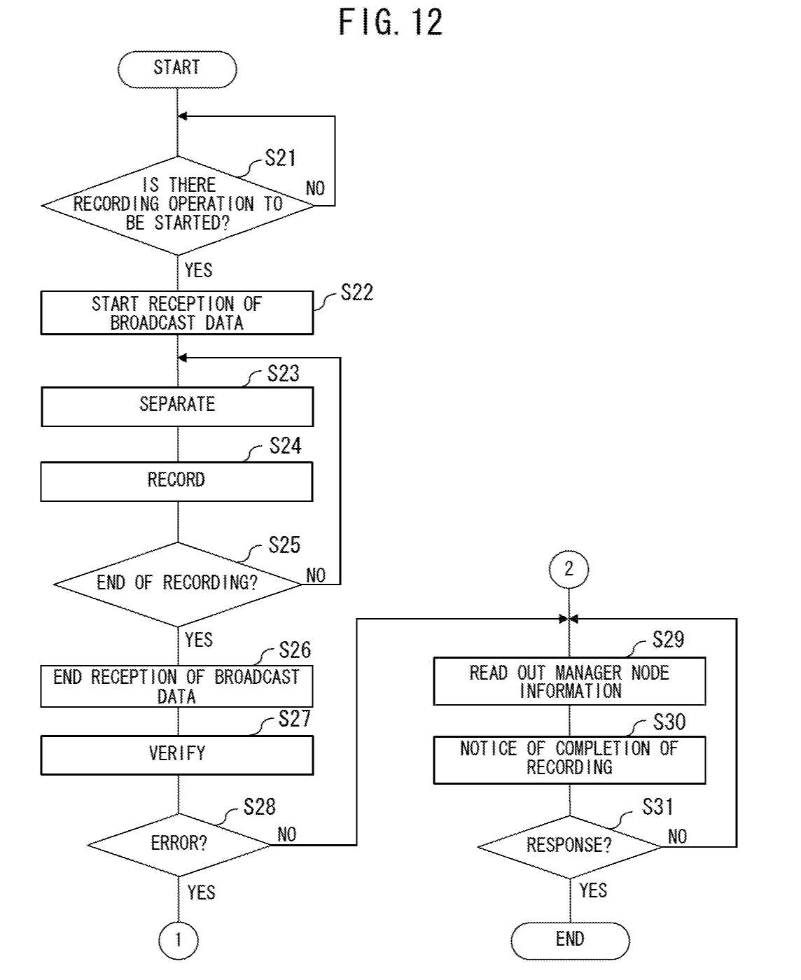

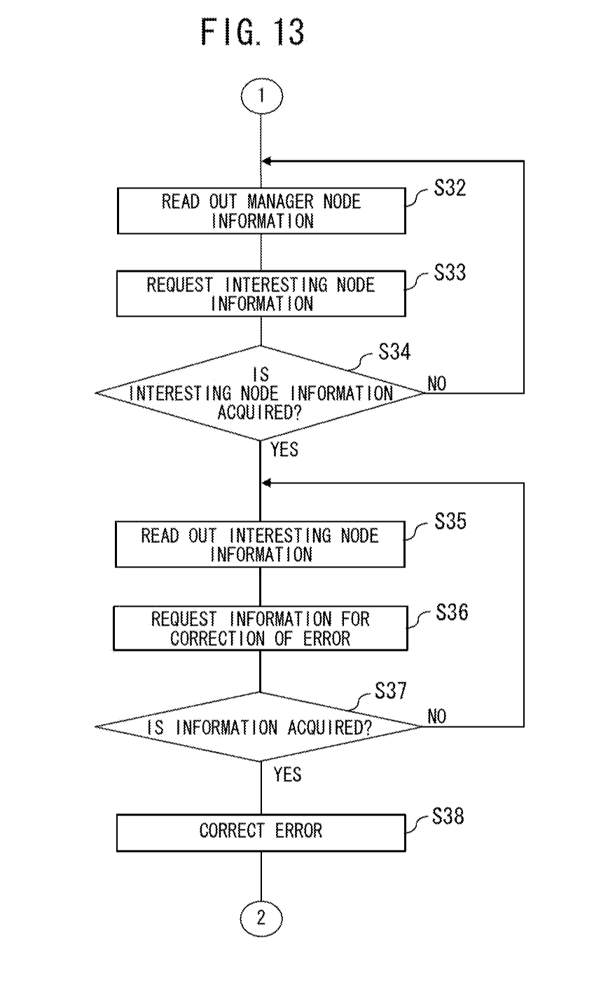

The receiver 2 receives the broadcast data in which the broadcast contents are multiplexed with the manager node information by the operations described above. Recording done by the receiver 2 is described with reference to the flowcharts illustrated in FIGS. 12 and 13. The following processing is performed by the control portion 20 according to a control program stored in the storage portion 21 of the receiver 2.

The control portion 20 of the receiver 2 determines whether there is a recording operation to be started (S21). In particular, if the user gives an instruction to start recording via the manual control portion 22, or if a recording start time indicated by reservation information stored in the storage portion 21 arrives, the control portion 20 determines that there is a recording operation to be started. If there is no recording operation to be started (NO at step S21), the control portion 20 enters a wait state.

If the control portion 20 determines that there is a recording operation to be started (YES at step S21), the control portion 20 starts to receive broadcast data corresponding to the recording operation to be started (S22). The control portion 20 separates the received broadcast data into broadcast contents and manager node information (S23) and records the broadcast contents and the manager node information into the content database 26b and manager node list 26a, respectively, on the recording medium 26 (S24).

The control portion 20 determines whether the started recording operation is to be terminated (S25). In particular, if the user gives an instruction to terminate the recording operation via the manual control portion 22 or if the recording end time indicated by the reservation information stored in the storage portion 21 arrives, the control portion 20 determines that the recording operation is to be terminated. If the recording operation is not to be terminated (NO at step S25), the control portion 20 returns to step S23, where each set of broadcast data received successively is divided into broadcast contents and manager node information (S23) and recorded on the recording medium 26 (S24).

The control portion 20 repeats the operations of steps S23-S25 until the control portion 20 determines that the recording operation is to be terminated. If the control portion 20 determines that the recording operation is to be terminated (YES at step S25), reception of broadcast data started at step S22 is terminated (S26). On completion of reception and recording of the broadcast data, the control portion 20 verifies the broadcast contents recorded in the content database 26b (S27).

The control portion 20 determines whether or not the broadcast contents contain an error according to the result of the verification (S28). If the control portion determines that there is no error (NO at step S28), the control portion reads manager node information corresponding to the content ID of the broadcast contents from the manager node list 26a (S29). The control portion 20 informs the manager node 2 indicated by the manager node information that the recording of the broadcast contents is completed (S30).

The control portion 20 determines whether or not there is a response from the manager node 2 to which the notice of completion of recording of the broadcast contents has been given (S31). If there is no response from the manager node 2 (NO at step S31), the control portion 20 returns to step S29, where manager node information of another manager node 2 corresponding to the content ID of the broadcast contents is read from the manager node list 26a (S29). The control portion 20 informs the other manager node 2 indicated by the read out manager node information that the recording of the broadcast contents is completed (S30).

The control portion 20 repeats the operations of steps S29-S31 until a response is obtained from the manager node 2 to which the notice of completion of the recording of the broadcast content has been given. If there is a response from the manager node 2 (YES at step S31), the control portion 20 terminates the recording operation.

On the other hand, if the control portion 20 determines that the broadcast contents contain an error (YES at step S28), the control portion 20 reads manager node information corresponding to the content ID of the broadcasts content from the manager node list 26a (S32, FIG. 13). The control portion 20 makes a request to the manager node 2 indicated by the read out manager node information for interesting node information corresponding to the broadcast contents (S33).

The control portion 20 determines whether appropriate interesting node information has been acquired from the manager node 2 that was asked to provide interesting node information (S34). If no appropriate interesting node information is acquired (NO at step S34), the control portion 20 returns to step S32, where manager node information of another manager node 2 corresponding to the content ID of the broadcast contents is read out from the manager node list 26a (S32). The control portion 20 makes a request to the manager node 2 indicated by the read out manager node information for interesting node information corresponding to the broadcast contents (S33).

The control portion 20 repeats the operations of steps S32-S34 until appropriate interesting node information is obtained from the manager node 2 that was asked to provide interesting node information. If appropriate interesting node information has been obtained (YES at S34), the control portion 20 stores the obtained interesting node information in the storage portion 21. The control portion 20 reads one of the sets of obtained interesting node information from the storage portion 21 (S35). The control portion 20 makes a request to the interesting node 2 indicated by the interesting node information for information to correct the error detected by the verification performed at step S27 (S36).

The control portion 20 determines whether appropriate information has been obtained from the interesting node 2 that was asked to provide information for correcting the error (S37). If no appropriate information has been obtained NO at step S37), the control portion 20 returns to step S35, where another set of the obtained interesting node information is read out from the storage portion 21 (S35). The control portion 20 makes a request to the interesting node 2 indicated by the other set of interesting node information, for information for correcting the error (S36).

The control portion 20 repeats the operations of steps S35-S37 until appropriate information is obtained from the interesting node 2 that was asked to provide information for correcting the error. If appropriate information has been obtained (YES at step S37), the control portion 20 corrects the error in the broadcast contents using the obtained information (S38). The control portion 20 goes to step S29, where the control portion reads out manager node information corresponding to the content ID of the broadcast contents from the manager node list 26a (S29). The control portion 20 informs the manager node 2 indicated by the manager node information that the recording of the broadcast contents has been completed (S30).

The control portion 20 determines whether or not there is a response from the manager node 2 to which the notice of completion of recording of the broadcast content has been given (S31). If there is no response from the manager node 2 (NO at step S31), the control portion 20 goes back to step S29, where the control portion reads another set of manager node information corresponding to the content ID of the broadcast contents from the manager node list 26a (S29). The control portion 20 informs the manager node 2 indicated by the other set of manager node information that the recording of the broadcast contents has been completed (S30).

The control portion 20 repeats the operations of steps S29-S31 until there is a response from a manager node 2 to which the notice of completion of recording of the broadcast content has been given. If the control portion 20 has determined that there is a response from the manager node 2 (YES at step S31), the recording operation is terminated.

As described previously, in the present embodiment (Embodiment 1), when the broadcast device 1 broadcasts broadcast contents, the broadcast device multiplexes manager node information indicating a manager node 2 holding interesting node information indicating an interesting node 2 in which the broadcast contents are recorded, with the broadcast contents. Consequently, when the receiver 2 receiving the broadcast contents wants to find an interesting node 2 that has recorded specific broadcast contents, the receiver may make an inquiry to the manager node 2 indicated by the manager node information multiplexed with the broadcast contents.

Therefore, it is not necessary for the receiver 2 itself to search for the interesting node 2 that has recorded the broadcast contents. This reduces communications among the receivers 2, which would normally be performed to search for interesting nodes 2. Hence, the communication burden is reduced. Furthermore, in the present embodiment (Embodiment 1), it is not necessary to install a server for managing which receivers 2 record which broadcast contents. For this reason, the cost that would normally be required to run the server may be reduced.

The broadcast device 1 of the present embodiment (Embodiment 1) broadcasts specific broadcast contents after multiplexing the specific broadcast contents with manager node information corresponding to the specific broadcast contents. However, the manager node information may be sent out at a timing different from the time at which the corresponding broadcast contents are broadcast. For example, before or after broadcasting broadcast contents having a content ID of 4,000, the broadcast device 1 may broadcast manager node information corresponding to the broadcast contents. In this case, the receiver 2 may broadcast manager node information, for example, as one data element of EPG information.

When specific broadcast contents received and recorded in the content database 26b contains an error, the receiver 2 of the present embodiment acquires information for correcting only the location of the error from the interesting node 2. However, the receiver 2 may also acquire, for example, all the information about the broadcast contents which contain an error from the interesting node 2.

The receiver 2 of the present embodiment (Embodiment 1) sends information for correcting the error in the broadcast contents, e.g., information indicating the content ID and the location of an error, to the interesting node 2. The receiver 2 of the present embodiment uses information such as, for example, by packet ID, PCR packets, or TOT packets, to indicate the location of the error. However, the receiver 2 may also indicate the range of an error, for example, using packet ID, PCR packets, or TOT packets and make a request to the interesting node 2 for only the video information, only the audio information, or video and audio information related to the indicated range of the error.

There is a possibility that information recorded by each different receiver 2 into the content database 26b is different due to the functions of the individual receivers 2. For example, some receivers 2 may record only video and audio signals. Other receivers 2 may record digital datacast signals, as well as video and audio signals. Therefore, when one receiver 2 makes a request to an interesting node 2 for information used to correct an error, the receiver 2 may previously check if the desired information is recorded in the content database 26b at the interesting node 2. In consequence, where there is a plurality of interesting nodes 2, the receiver 2 may identify the interesting node 2 holding desired information and thus may acquire the desired information.

In the above-described Embodiment 1, when recording of the received broadcast contents into the content database 26b is completed, the receiver 2 verifies whether or not the broadcast contents recorded in the content database 26b contains an error. Alternatively, whenever a given amount of information of specific broadcast contents is recorded in the content database 26b, the receiver 2 may verify whether the information recorded in the content database 26b contains an error. In this case, whenever the receiver 2 detects an error in the given amount of information recorded in the content database 26b, information for correcting the error may be acquired from the interesting node 2 for the receiver 2 to correct the error. This type of processing makes it possible to view error-corrected broadcast contents even while an already recorded broadcast content is being played back while recording the received broadcast contents (e.g., time-shifted viewing).

### EMBODIMENT 2

A broadcast system associated with Embodiment 2 is described below. Because the broadcast system of the present embodiment may be realized by a configuration similar to the configuration of the broadcast system of the above-described Embodiment 1, like components are indicated by like reference numerals, and those components which have been already described will not be described below.

In the above-described Embodiment 1, no limitations are imposed on the method of assigning manager nodes 2 to individual broadcast contents via the broadcast device 1. The broadcast device 1 of the present embodiment (Embodiment 2) calculates the hash values of the broadcast contents using a distributed hash table (DHT). The broadcast device 1 assigns receivers 2 of node IDs having hash values closer to the hash values of the broadcast contents to manager nodes 2 out of hash values of other node IDs assigned to the receivers 2 connected with the network N. The receivers 2 of Embodiment 2 operate similarly to the receivers 2 of the above-described Embodiment 1.

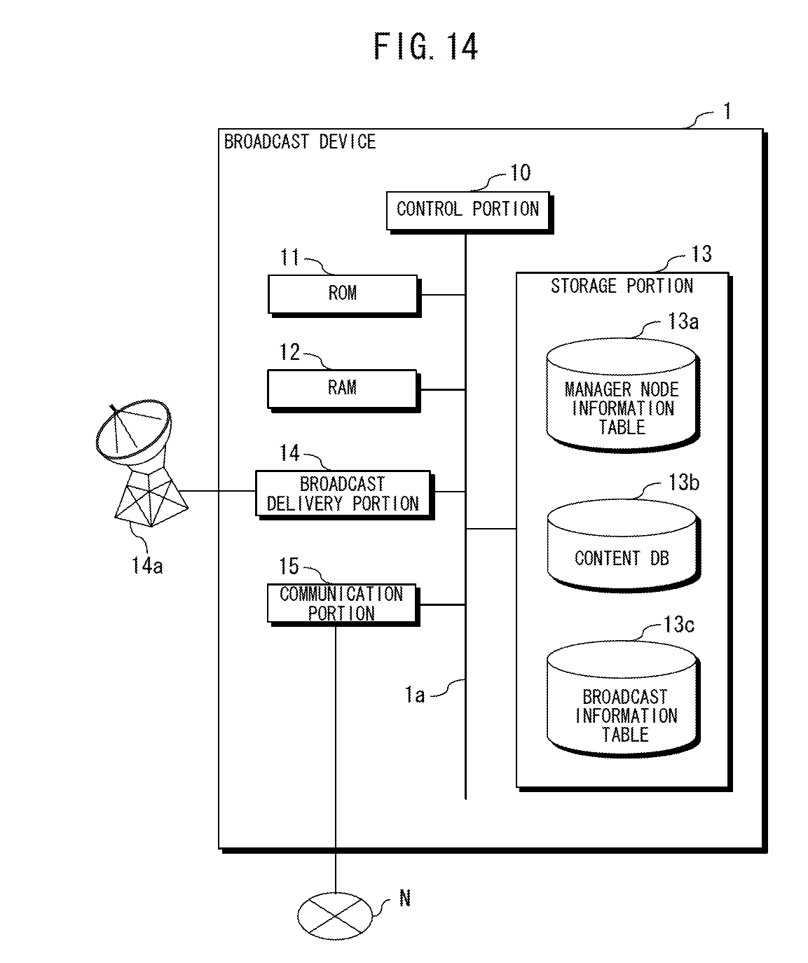

FIG. 14 is a block diagram illustrating an example of a configuration of the broadcast device 1 of Embodiment 2. The broadcast device 1 of the present embodiment has a communication portion 15 for connection with the network N, in addition to the various parts illustrated in FIG. 2. The communication portion 15 performs communications with the receivers 2 via the network N. The communication portion 15 performs P2P packet communications with the receivers 2 via the network N, for example, based on the communications parameters of the receivers 2. For example, the communications parameters may be IP addresses and/or port numbers assigned to the receivers 2.

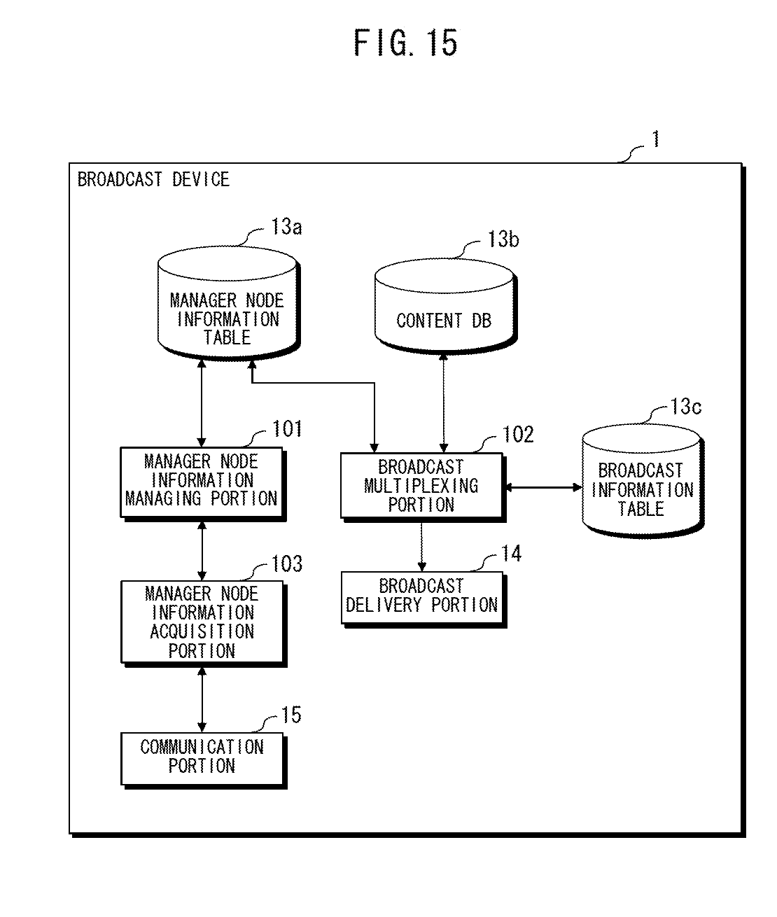

The control portion 10 of the broadcast device 1 in the broadcast system of the present embodiment (Embodiment 2) executes a control program stored in the ROM 11 or the storage portion 13, thus realizing functions which are described below. FIG. 15 is a functional block diagram illustrating a functional configuration example of the broadcast device 1 of Embodiment 2. The control portion 10 of the broadcast device 1 of the present embodiment executes the control program stored in the ROM 11 or storage portion 13, thus realizing the functions of a manager node information acquisition portion 103, in addition to the various portions illustrated in FIG. 7.

In the broadcast system of the present embodiment (Embodiment 2), when new broadcast contents to be broadcast are created, the manager node information acquisition portion 103 of the broadcast device 1 requests information about a manager node to be assigned to the created broadcast contents, via the communication portion 15. In particular, the manager node information acquisition portion 103 calculates the hash values of the content IDs of broadcast contents, for example, based on the distributed hash table (DHT), and makes a request to the network N for information about the manager nodes to be assigned to the broadcast contents based on the calculated hash values.

More specifically, the manager node information acquisition portion 103 sends messages including the node ID, IP address, port number of the broadcast device 1, and the hash value of the content ID of the broadcast contents to the receiver 2 via the network N. The acquisition portion 103 sends a query message to the receivers 2 having the hash values of the node IDs close to the hash value of the broadcast contents out of the hash values of the receivers 2 connected, for example, via the network N. For example, the node IDs may be values calculated from the IP addresses and port numbers of nodes including the broadcast device 1 and receivers 2, and may provide information to uniquely identify the nodes.

The receiver 2 receiving the message determines, using the DHT method, whether the receivers 2 connected via the network N include another receiver 2 having a hash value of a node ID closer to the hash value of the broadcast contents than the hash value of the node ID of the receiver 2. If the receiver 2 receiving the message determines that there is a receiver 2 having a hash value closer to the hash value of the broadcast contents than the hash value of the node ID of the receiver 2, the received message is sent to the receiver 2 having the hash value closer to the hash value of the broadcast contents.

When each receiver 2 receives a message as mentioned above, if there is a receiver 2 having a hash value closer to the hash value of the broadcast contents than the hash value of the node ID of the receiver 2, forwarding of the message to the receiver 2 is repeated. If there is no receiver 2 having a hash value closer to the hash value of the broadcast contents than the hash value of the node ID of the receiver 2, the receiver 2 receiving the message determines that the receiver 2 itself is the manager node for the broadcast contents. Each receiver 2 may also determine that it is a manager node for the broadcast contents when the difference between the hash value of the node ID of the receiver and the hash value of the broadcast contents is less than a given value.

A receiver 2 that has determined that the receiver 2 itself is a manager node 2 sends manager node information including the IP address and port number of the receiver 2 itself to the broadcast device 1. Based on the IP address and port number of the broadcast device 1 contained in the received message, the manager node 2 sends the hash value of the broadcast contents and information about itself (manager node information) included in the received message to the broadcast device 1. When the manager node 2 has determined that the manager node 2 itself is a manager node, the manager node 2 may also store the content ID indicating that the manager node 2 is a manager node into the interesting nodes list 21a.

The manager node information acquisition portion 103 of the broadcast device 1 acquires, via the communication portion 15, the content ID and manager node information in the broadcast contents sent by the manager node 2 in response to a message asking for manager node information. The manager node information acquisition portion 103 sends the hash value of the acquired broadcast contents and the manager node information to the manager node information managing portion 101.

The manager node information managing portion 101 of the present embodiment (Embodiment 2) identifies a content ID corresponding to the hash value obtained from the manager node information acquisition portion 103 and stores the manager node information obtained from the manager node information acquisition portion 103 in the manager node information table 13a in association with the identified content ID. Consequently, as illustrated in FIG. 3A, content ID and information about the manager node corresponding to specific broadcast contents are stored in the manager node information table 13a.

In the broadcast system of the present embodiment (Embodiment 2), various portions other than the manager node information acquisition portion 103 and manager node information managing portion 101 of the broadcast device 1 operate similarly to like portions of the above-described Embodiment 1 and so description is omitted.

As described previously, the broadcast device 1 of the present embodiment uses the manager node 2 corresponding to specific broadcast contents as the receiver 2 of a node ID closer to the hash value of the broadcast contents. Therefore, the manager nodes 2 for the broadcast contents may be distributed to a plurality of receivers 2. Hence, the load on each manager node 2 may be reduced.

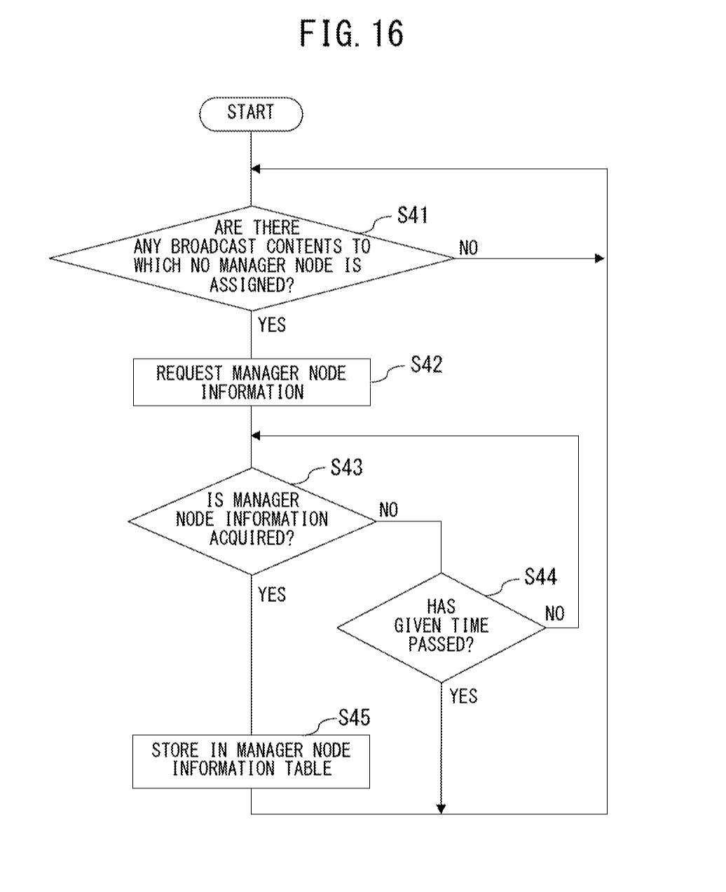

Processing performed by the broadcast device 1 of the broadcast system of the present embodiment (Embodiment 2) to assign manager nodes to broadcast contents is described below with reference to the flowchart of FIG. 16. The following processing is executed by the control portion 10 according to a control program stored in the ROM 11 or storage portion 13 of the broadcast device 1.

The control portion 10 of the broadcast device 1 determines whether there are any broadcast contents to which no manager node 2 is assigned yet (S41). If there no broadcast contents to which no manager node 2 has been assigned (NO at step S41), the control portion enters a wait state. If there are broadcast contents to which no manager node 2 has been assigned yet (YES at step S41), the control portion 10 makes a request to the receivers 2 for information about the manager node to be assigned to the broadcast contents, via the network N (S42).

The control portion 10 determines whether manager node information has been acquired from a receiver 2 via the network N (S43). If no manager node information has been acquired (NO at step S43), the control portion 10 determines whether a given time has passed since the manager node information has been requested (S44). If the given time has not passed (No at step S44), the control portion 10 transfers to step S43. If the given time has passed (YES at step 44), the control portion 10 returns to step S41.

If the manager node information has been acquired from a receiver 2 (YES at step S43), the control portion 10 stores the acquired manager node information in the manager node information table 13a so that the acquired manager node information is associated with the corresponding comment ID (S45). The control portion 10 returns to step S41, where the control portion 10 assigns manager nodes 2 to broadcast contents to which manager nodes 2 have not yet been assigned.

The processing performed by the broadcast device 1 of the present embodiment (Embodiment 2) to broadcast contents is the same as the processing of Embodiment 1 described in connection with FIG. 11 and so description is omitted.

Furthermore, in the broadcast system of Embodiment 2, the recording operation performed by the receiver 2 receiving broadcast data in which the broadcast contents are multiplexed with the manager node information is the same as the operation of Embodiment 1 described in connection with FIGS. 12 and 13 and so the description is omitted.

As described previously, in the present embodiment (Embodiment 2), only the broadcast device 1 sends a message for requesting (searching for) manager nodes 2 corresponding to the broadcast contents. Consequently, communications that would be normally performed between receivers 2 when each receiver 2 searches for interesting nodes 2 are reduced with. This reduces the communication load on the network N. Furthermore, in the present embodiment, the broadcast device 1 causes a receiver 2 having a node ID close to the hash value of specific broadcast contents to be operated as a manager node 2. In consequence, manager nodes 2 corresponding to the broadcast contents may be caused to distribute broadcast contents to receivers 2.

Where the broadcast device 1 of Embodiment 2 makes a request via the network N for information about manager nodes to be assigned to broadcast contents, manager node information acquired via the network N from manager nodes 2 is stored in the manager node information table 13a. Furthermore, the broadcast device 1 may control the amount of manager node information stored in the manager node information table 13a for specific broadcast contents. For example, when only a given number of sets of manager node information are stored in the manager node information table 13a for specific broadcast contents, if the given number is reached or exceeded, the broadcast device 1 may delete each set of manager node information in turn from the table 13a starting from the oldest set of manager node information.

### EMBODIMENT 3

A broadcast system related to Embodiment 3 is described below. Because the broadcast system of the present embodiment may be accomplished by a configuration similar to the broadcast system of Embodiment 2 described above, like components are indicated by like reference numerals, and those components which have been already described will not be described below.

In the above-described Embodiment 2, when new broadcast contents are created, for example, the broadcast device 1 sends a message asking for information about manager nodes 2 for broadcast contents via the network N. The broadcast device 1 of Embodiment 3 sends, via the network N, a message asking for information about manager nodes 2 for broadcast contents preceding the start of broadcasting of the broadcast contents by a given time. The receivers 2 of Embodiment 3 operate similarly to the receivers 2 of the above-described Embodiment 1.

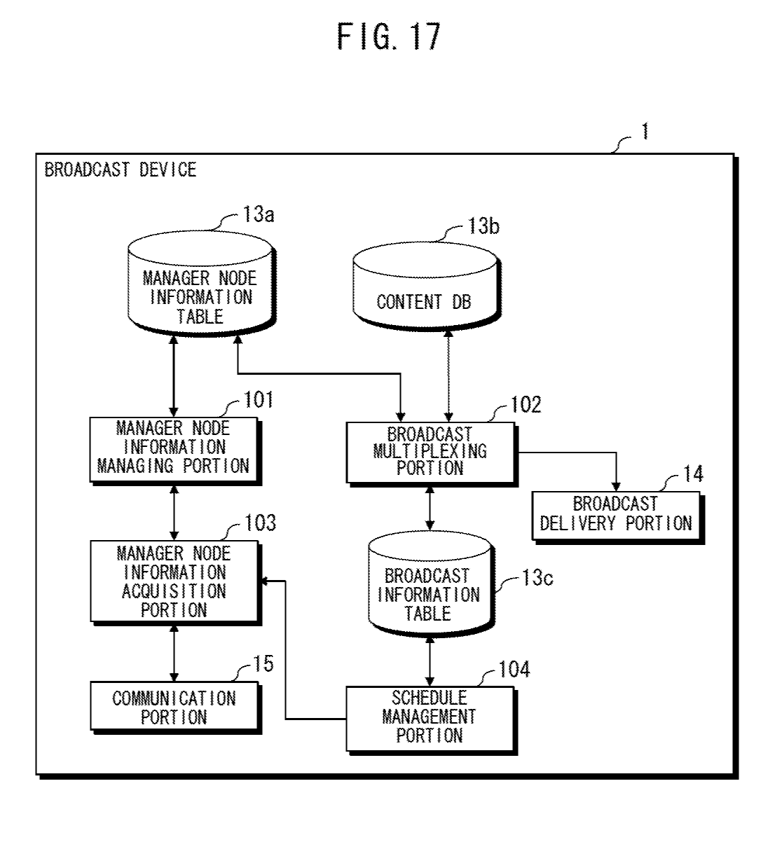

FIG. 17 is a functional block diagram illustrating an example of functional configuration of the broadcast device 1 of Embodiment 3. In the broadcast device 1 of the present embodiment, the control portion 10 realizes the functions of a schedule management portion 104 as well as the functions of the various portions illustrated in FIG. 15 by executing a control program stored in the ROM 11 or storage portion 13.

In the broadcast device 1 of Embodiment 3, the schedule management portion 104 monitors the storage details of the broadcast information table 13c and determines whether there are broadcast contents to be broadcast within a given time (e.g., 1 hour) from the current time. In particular, the schedule management portion 104 determines whether or not there are broadcast contents which are stored in the broadcast information table 13c and whose program start time arrives within the given time from the current time. If the decision is that there is are specific broadcast contents whose program start time arrives within the given time from the current time, the schedule management portion 104 reads the content ID of the specific broadcast contents from the broadcast information table 13c.

The schedule management portion 104 may monitor the program start time of specific broadcast contents, for example, based on preset EPG information in addition to the storage details in the broadcast information table 13c. Alternatively, the broadcast device 1 may be made accessible to an external device that manages the broadcast schedule. The schedule management portion 104 accesses the broadcast schedule managed by the external device and monitors the program start times of the broadcast contents based on the broadcast schedule.

The schedule management portion 104 notifies the manager node information acquisition portion 103 of the content ID read out from the broadcast information table 13c.

When notified of the content ID from the schedule management portion 104, the manager node information acquisition portion 103 of Embodiment 3 makes a request for information about the manager node to be assigned to specific broadcast contents having the notified content ID, via the communication portion 15.

The manager node information acquisition portion 103 of the present embodiment calculates the hash value of the notified content ID from the schedule management portion 104 based on a DHT. The acquisition portion 103 sends a message including node ID, IP address, and port number of its broadcast device 1 and the calculated hash value of the broadcast contents to the receiver 2 via the network N. If a receiver 2 having a hash value closer to the hash value of the broadcast contents than the hash value of the node ID of the present receiver is found using a DHT method, then the receiver 2 receiving the message sends the received message to the receiver 2 having a hash value closer to the hash value of the broadcast contents.

The manager node information acquisition portion 103 of Embodiment 3 acquires, via the communication portion 15, the content ID and manager node information of the broadcast contents sent back by the manager node 2 in response to the message in the same way as the manager node information acquisition portion 103 of Embodiment 2 described above.

In the broadcast system of Embodiment 2, the various portions of the broadcast device 1 operate similarly to like portions of the above-described Embodiments 1 and 2, except for the schedule management portion 104 and manager node information acquisition portion 103, and so description is omitted.

As described previously, the broadcast device 1 of the present embodiment (Embodiment 3) acquires information about manager nodes 2 for the broadcast contents before the program start time of specific broadcast contents by a given time. Therefore, the manager nodes 2 are assigned to the broadcast contents before the broadcast contents are broadcast. Consequently, assignment of the manager nodes 2 to the broadcast contents may be ensured.

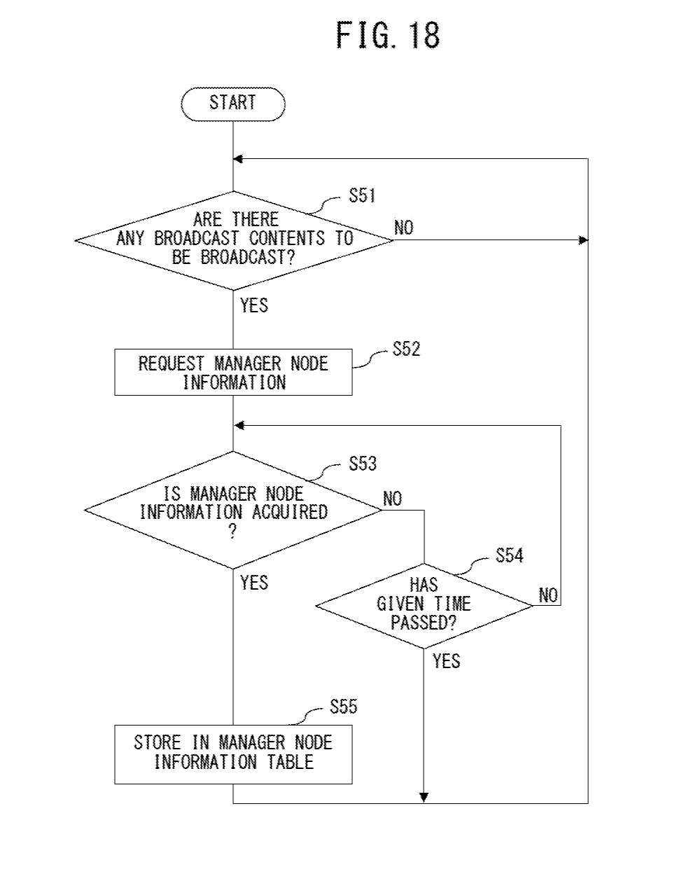

Processing performed by the broadcast device 1 of the broadcast system of Embodiment 3 to assign manager nodes to broadcast contents is described below with reference to the flowchart of FIG. 18. The following processing is carried out by the control portion 10 in accordance with a control program stored in the ROM 11 or storage portion 13 of the broadcast device 1.

The control portion 10 of the broadcast device 1 determines, based on the storage details of the broadcast information table 13c, whether or not there are broadcast contents to be broadcast within a given time from the current time (S51). If the control portion 10 determines that there are no broadcast contents to be broadcast within a given time (NO at step S51), the control portion enters a wait state. If there are broadcast contents to be broadcast (Yes at step S51), the control portion 10 makes a request to the receivers 2 via the network N for information about a manager node to be assigned to the broadcast contents (S52).

The control portion 10 determines whether or not manager node information has been acquired from a receiver 2 via the network N (S53). If no manager node information has been acquired (NO at step S53), the control portion 10 determines whether or not a given time has passed since the manager node information has been requested (S54). If the given time has not passed (No at step S54), the control portion 10 transfers back to step S53. If the control portion 10 determines that the given time has passed (YES at step S54), the control portion 10 returns to step S51.

If the manager node information has been acquired from a receiver (YES at step S53), the control portion 10 stores the acquired manager node information in the manager node information table 13a so that the node information is associated with the corresponding content ID (S55). The control portion 10 transfers back to step S51.

Processing performed by the broadcast device 1 of the present embodiment (Embodiment 3) to broadcast contents is the same as the processing of Embodiment 1 described in connection with FIG. 11 and so description is omitted.

Furthermore, in the broadcast system of the present embodiment (Embodiment 3), the recording operation performed by the receiver 2 receiving broadcast data in which broadcast contents is multiplexed with manager node information is the same as the operation of Embodiment 1 already described in connection with FIGS. 12 and 13 and so description is omitted.

As described previously, in Embodiment 3, information about manager nodes 2 for broadcast contents is gathered before the program start time of the broadcast contents by a given time. Consequently, assignment of manager nodes 2 to broadcast contents may be ensured.

In the broadcast device 1 of the above-described Embodiment 2, when new broadcast contents are created, the operation for gathering information about the manager nodes for the broadcast contents is started. The broadcast device 1 of Embodiment 3 starts the operation for gathering information about manager nodes corresponding to the broadcast contents before the program start time of the broadcast contents by a given time.

The embodiment 3 is not limited to this configuration. For example, an administrator who manages the broadcast device 1 may give an instruction for starting collection of information about the manager nodes. Furthermore, when the broadcast contents that are broadcast sequentially are switched, the broadcast device 1 may gather information about the manager nodes for the broadcast contents to be broadcast next. Moreover, during the broadcast of broadcast contents, new information about the manager node for the broadcast contents may be gathered periodically. The information about the manager nodes for broadcast contents may be updated at regular intervals.

### EMBODIMENT 4

A broadcast system associated with Embodiment 4 is described below. The broadcast system of the present embodiment may be realized by a configuration similar to the broadcast system of the above-described Embodiment 1. Like components are indicated by like reference numerals and those components which have been already described will not be described below.

In the above-described Embodiment 1, each receiver 2 stores every set of manager node information that is obtained by dividing received broadcast data, in the manager node list 26a. A receiver 2 of Embodiment 4 selects manager node information according to given conditions from the obtained manager node information separated from the broadcast data, and stores only the selected sets of manager node information in the manager node list 26a. Each broadcast device 1 of Embodiment 4 operates similarly to each broadcast device 1 of the above-described Embodiment 1.

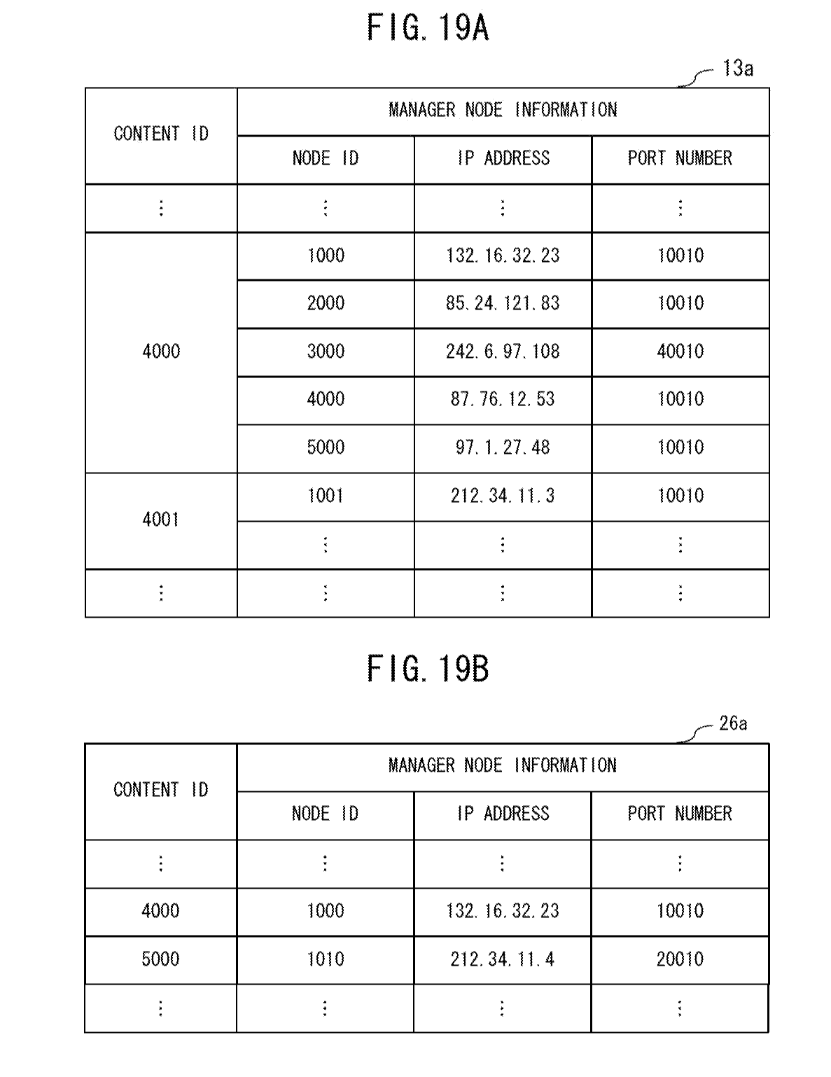

FIGS. 19A and 19B are schematic diagrams illustrating the storage details of a manager node information table 13a and a locally holded manager node list 126a, respectively, according to Embodiment 4. The manager node information table 13a stored in the storage portion 13 of the broadcast device 1 of Embodiment 4 is illustrated in FIG. 19A. The locally holded manager node list 126a stored on the recording medium 26 of each receiver 2 of Embodiment 4 is illustrated in FIG. 19B.

As illustrated in FIG. 19A, the manager node information stored in the manager node information table 13a of Embodiment 4 includes the node IDs of manager nodes 2 in addition to the IP addresses and port numbers of the manager nodes 2 assigned to the broadcast contents. For example, the node IDs are values calculated from the IP addresses and port numbers of the manager nodes 2 and provide information making it possible to uniquely identify the manager nodes 2.

The broadcast multiplexing portion 102 of the present embodiment (Embodiment 4) creates broadcast data by multiplexing specific broadcast contents with the manager node information stored in the manager node information table 13a in association with the broadcast contents, and broadcasts the created broadcast data via the broadcast delivery portion 14. Therefore, as illustrated in FIG. 19B, receiver 2 filters the manager node information table 13, and stores the locally holded manager node list 126a.

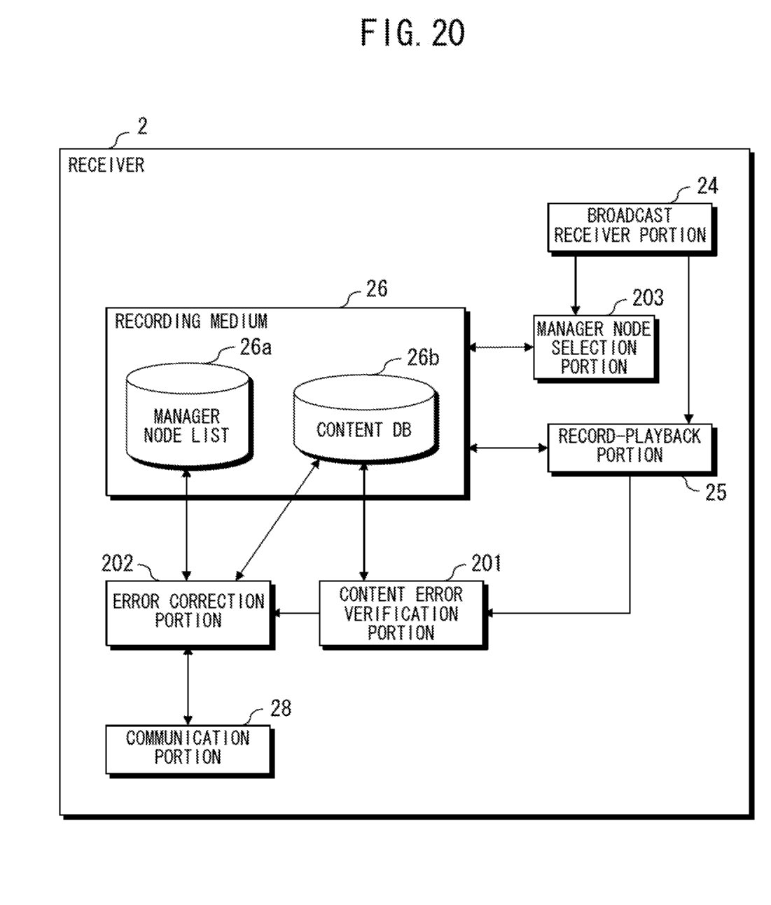

FIG. 20 is a functional block diagram illustrating an example of functional configuration of a receiver 2 according to Embodiment 4. In the receiver 2 of the present embodiment, the control portion 20 realizes the functions of a manager node selection portion 203 as well as the functions of various portions illustrated in FIG. 9 by executing a control program stored in the storage portion 21.

In the receiver 2 of Embodiment 4, the broadcast receiver portion 24 receives broadcast data broadcast by the broadcast device 1 and separates the received broadcast data into broadcast contents and manager node information. The broadcast receiver portion 24 of Embodiment 4 sends the broadcast contents extracted from the broadcast data to the record-playback portion 25 and sends the manager node information extracted from the broadcast data to the manager node selection portion 203. The record-playback portion 25 records the broadcast contents sent from the broadcast receiver portion 24 into the content database 26b on the recording medium 26 so that the broadcast contents correspond to the content IDs.

The manager node selection portion 203 selects manager node information complying with given conditions from the manager node information sent from the broadcast receiver portion 24. The manager node selection portion 203 calculates the difference between the node ID of each set of manager node information sent from the broadcast receiver portion 24 and the node ID of the receiver 2 and selects the manager node information having the calculated difference value less than a given value. The manager node selection portion 203 may select the manager node information about a manager node a short network distance away from the receiver 2. The manager node selection portion 203 records the selected manager node information in the manager node list 26a on the recording medium 26 so that the selected information corresponds to the content ID.

The selection condition is not limited to the above example. For example, the manager node selection portion 203 may select manager node information in which the difference between the node ID of each set of manager node information sent from the broadcast receiver portion 24 and the node ID of the receiver 2 is equal to or greater than a given value. Alternatively, the manager node selection portion 203 may select manager node information about a manager node a large network distance away from the receiver 2. For example, the manager node selection portion 203 may compare the IP address indicated by the manager node information sent from the broadcast receiver portion 24 with the IP address of the receiver 2 and select manager node information providing a difference equal to or greater than the given value (i.e., manager node information about a manager node a large network distance away). Consequently, manager nodes managing receivers 2 placed under different environmental conditions when broadcast contents are received may be selected. For example, the quality of broadcast contents distributed by airwaves is easily affected by weather conditions during reception. It is expected that a manager node a large network distance away will also be a large physical distance away and is highly likely to manage information about receivers 2 under different environmental conditions such as weather conditions when the broadcast contents are received. Where the quality of the broadcast contents received by one receiver 2 is low, the broadcast contents received under environmental conditions different from the environment conditions of the one receiver 2 are obtained. Thus, broadcast contents of high reception quality may be obtained.

Because a receiver 2 of Embodiment 4 has the manager node selection portion 203, the amount of manager node information stored in the manager node list 26a may be reduced. Therefore, the storage capacity desired for the manager node list 26a may be reduced. Especially, where manager node information about broadcast contents scheduled to be broadcast irrespective of whether the receiver 2 actually records the broadcast contents is delivered in advance, it is possible to make effective use of the recording medium 26 of the receiver 2 by reducing the amount of manager node information stored in the manager node list 26a.

In the broadcast system of Embodiment 4, various portions of the receiver 2 other than the manager node selection portion 203 operate similarly to the portions of the above-described Embodiment 1 and so description is omitted.

As described previously, the receiver 2 of the present embodiment (Embodiment 4) selects node IDs in which a difference with the node ID of the receiver 2 is equal to or less than a given value from node IDs contained in the manager node information extracted from the received broadcast data. Then, the receiver 2 stores only the manager node information including the selected node IDs in the manager node information table 13a and uses the information as information about the manager node to which an inquiry is made by the receiver 2. Consequently, the manager nodes to which inquiries are made by the receivers 2 may be distributed. Hence, the load on each manager node 2 may be reduced.

In the broadcast system of the present embodiment (Embodiment 4), processing performed by the broadcast device 1 to assign manager nodes to broadcast contents is the same as the processing of the above-described Embodiment 1 already described in connection with FIG. 10 and so description is omitted. Furthermore, the processing performed by the broadcast device 1 of Embodiment 4 to broadcast contents is the same as the processing of Embodiment 1 already described in connection with FIG. 11 and so description is omitted.

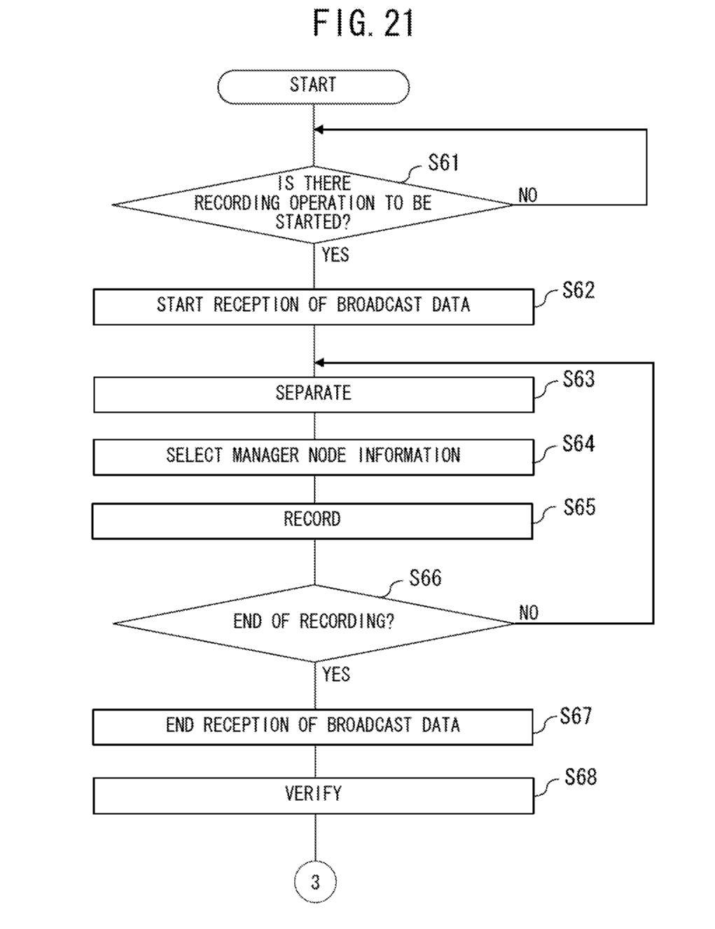

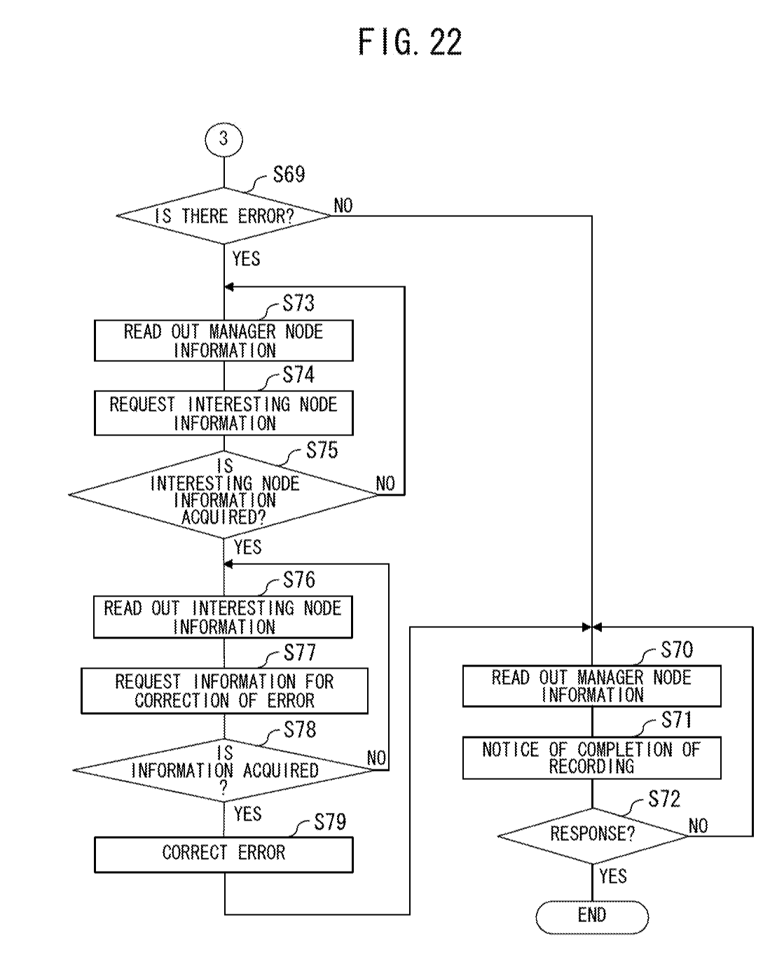

In the broadcast system of Embodiment 4, processing performed by the receiver 2 receiving broadcast data in which broadcast contents are multiplexed with manager node information to perform a recording operation is next described with reference to the flowcharts of FIGS. 21 and 22. The following processing is carried out by the control portion 20 in accordance with a control program stored in the storage portion 21 of the receiver 2.

The control portion 20 of the receiver 2 determines whether there is a recording operation to be started (S61). In particular, when the user gives an instruction for starting recording via the manual control portion 22 or when a program start time indicated by reservation information stored in the storage portion 21 arrives, the control portion 20 determines that there is a recording operation to be started. If there is no recording operation to be started (NO at step S61), the control portion 20 enters a wait state.

If t there is a recording operation to be started (YES at step S61), the control portion 20 starts to receive broadcast data corresponding to the recording operation to be started (S62). The control portion 20 separates the received broadcast data into broadcast contents and manager node information (S63). The control portion 20 selects manager node information complying with given conditions from the manager node information extracted from the broadcast data (S64). The control portion 20 records the broadcast contents extracted from the broadcast data and the selected manager node information into the content database 26b and the manager node list 26a, respectively, on the recording medium 26 (S65).

The control portion 20 determines whether the started recording operation is to be terminated (S66). In particular, when the user gives an instruction for terminating the recording operation via the manual control portion 22 or when the recording end time indicated by reservation information stored in the storage portion 21 arrives, the control portion 20 determines that the recording operation is to be terminated. If the control portion 20 determines that the recording operation is not to be terminated NO at step S66), the control portion 20 returns to step S63, where successively received broadcast data is divided into broadcast contents and manager node information (S63).

The control portion 20 repeats the operations of steps S63-S66 until the control portion 20 determines that the recording operation is to be terminated. If the control portion 20 determines that the recording operation is to be terminated (YES at step S66), reception of broadcast data started at step S62 is terminated (S67). When reception and recording of broadcast data are ended, the control portion 20 verifies the broadcast contents recorded in the content database 26b (S68). The operations of the subsequent steps S69-S79 are the same as the operations of steps S28-S38 of Embodiment 1 already described in connection with FIGS. 12 and 13 and so description is omitted.

As described previously, in the present embodiment (Embodiment 4), the receiver 2 selects only manager node information complying with given conditions from the manager node information, which is multiplexed with the received broadcast contents and distributed, and stores the selected information in the manager node list 26a. Consequently, the amount of manager node information stored in the manager node list 26a may be reduced. The storage capacity of the manager node list 26a may be reduced.

While Embodiment 4 has been described as a modification of the above-described Embodiment 1, Embodiment 4 may also be applied to the configurations of Embodiments 2 and 3 described above.

### EMBODIMENT 5

A broadcast system associated with Embodiment 5 is described below. Because the broadcast system of Embodiment 5 may be realized by a configuration similar to the broadcast system of the above-described Embodiment 1, like components are indicated by like reference numerals. Like components which have been already described will not be described below.

In the above-described Embodiments 1-4, it is assumed that the manager node 2 is any one of receivers 2 connected with the network N. In contrast, the broadcast system of Embodiment 5 has a manager node device 3 operating only as a manager node.

In the broadcast system of Embodiment 5, the manager node device 3 is connected with the network N in addition to the receivers 2 (not illustrated). A plurality of manager node devices 3 may also be connected with the network N.

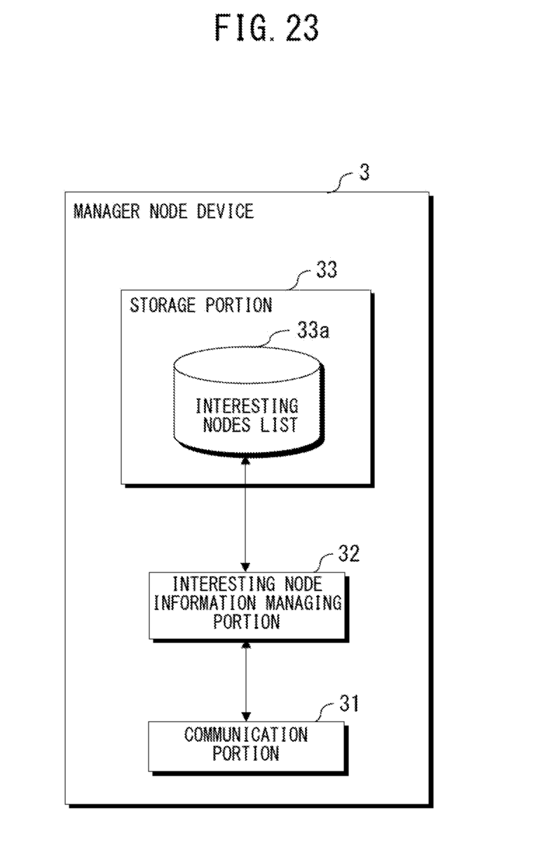

FIG. 23 is a functional block diagram illustrating an example of a functional configuration of the manager node device 3 according to Embodiment 5. As an example, the manager node device 3 may be a well-known server computer, and has a communication portion 31 being an interface for connection with the network N, a storage portion 33 for storing an interesting nodes list 33a as illustrated in FIG. 6, and an interesting node management portion 32 for managing the interesting nodes list 33a.

The communication portion 31 performs P2P packet communications with the receivers 2 via the network N, for example, based on communications parameters (such as IP address and port number) of the receivers 2. The storage portion 33 includes, for example, a hard disk drive or flash memory. Various control programs to operate the manager node device 3 are previously stored in the storage portion 33.

The manager node device 3 is notified of completion of recording of broadcast contents by the receivers (nodes of interest) 2 via the network N. Where a notice of completion of recording of the broadcast contents is received from the receivers 2, the interesting node information management portion 32 of the manager node device 3 acquires the content ID of the broadcast contents already recorded and the IP address and port number of the receiver 2 giving the notice of completion of the recording, via the communication portion 31. The interesting node information management portion 32 uses the acquired IP address and port number of the receiver 2 as interesting node information and stores the interesting node information in the interesting nodes list 33a so that the interesting node information is associated with the acquired content ID. As a result, content IDs and interesting node information for the broadcast contents are stored in the interesting nodes list 33a, in the same way as the interesting nodes list 21a illustrated in FIG. 6.

The manager node device 3 is asked for interesting node information from the receivers 2 via the network N. When interesting node information is requested, the interesting node information management portion 32 of the manager node device 3 acquires the IP address and port number of the receiver 2 requesting the interesting node information, as well as the content ID corresponding to the requested interesting node information, via the communication portion 31. The management portion 32 reads the requested interesting node information from the interesting nodes list 33a and sends the interesting node information to the requesting receiver 2. When the manager node device 3 does not hold the interesting node information requested from the receiver 2, the node device 3 sends a message to the effect that node device 3 does not hold the requested interesting node information to the receiver 2 requesting the interesting node information.

Where the manager node device 3 does not hold the interesting node information requested from the receiver 2, the manager node device 3 may suspend responding to the receiver 2. If the requested interesting node information is acquired from a receiver 2 that is an interesting node, the manager node device 3 may send the information to the requesting receiver 2. Alternatively, the manager node device 3 may suspend responding to the receiver 2 until a certain amount of interesting node information is accumulated, whereafter the manager node device 3 may send the accumulated interesting node information to the requesting receiver 2.

In the broadcast device 1 of the present embodiment (Embodiment 5), information such as IP address and port number about the manager node device 3 as described above is previously stored in a plurality of storage portions 13. The manager node information managing portion 101 of the broadcast device 1 reads out information about a given number of manager node devices 3 from the information about the manager node device 3 stored in the storage portions 13 and assigns the manager nodes 3 indicated by the read out information as manager nodes for broadcast contents.

One method of selecting the manager node devices 3 to be assigned as manager nodes includes selecting manager node devices 3 having node IDs close to the content IDs of the broadcast contents when the node IDs are assigned to the manager node devices 3. Other methods may also be used. In another method, the hash value of the content ID of the broadcast contents and the hash value of the node ID of each manager node device 3 are compared, and the manager node 3 having the node ID of a hash value closer to the hash value of the content ID is selected. The number of manager nodes 3 assigned to specific broadcast contents may be one or more.

The manager node information managing portion 101 reads information about the manager node device 3 to be assigned to the broadcast contents from the storage portion 13 and stores the information in the manager node information table 13a so that the information about the manager node device 3 is associated with the content ID of the broadcast contents. Consequently, as illustrated in FIG. 3A, content IDs and the information about the manager node devices 3 assigned to the broadcast contents are stored in the manager node information table 13a.

In the broadcast system of the present embodiment (Embodiment 5), the processing performed by the broadcast device 1 to assign manager nodes to broadcast contents is the same as the processing performed by the above-described Embodiment 1 already described in connection with FIG. 10, and so description is omitted. The control portion 10 of the broadcast device 1 of the present embodiment selects one of the manager node devices 3 and assigns the selected manager node device 3 as the manager node 2 for specific broadcast contents at step S2 of FIG. 10.

The processing performed by the broadcast device 1 of Embodiment 5 to broadcast contents is the same as the processing of the above-described Embodiment 1 already described in connection with FIG. 11 and so description is omitted. Furthermore, in the broadcast system of the present embodiment (Embodiment 5), the processing performed by the receiver 2 receiving broadcast data in which the broadcast contents are multiplexed with the manager node information is the same as the processing of the above-described Embodiment 1 already described in connection with FIGS. 12 and 13 and so description is omitted.

As described previously, in Embodiment 5, manager nodes 2 assigned to broadcast contents are selected from the manager node devices 3 connected with the network N. Therefore, the manager node devices 3 may gather information about the interesting nodes 2 for broadcast contents, for example, by assigning constantly operating manager node devices 3 to the manager nodes 2 for specific broadcast contents. In addition, the receivers 2 may acquire information for correcting errors in the broadcast contents from manager node devices 3. As a consequence, efficient error corrections may be performed.

In the broadcast device 1 of Embodiment 5, any one or more of the manager node devices 3 connected with the network N may be used as the manager nodes 2 to be assigned to broadcast contents. Embodiment 5 may be combined with the above-described Embodiments 1-4. Manager nodes 2 for broadcast contents may be selected from manager node devices 3 and receivers 2.

In the above-described Embodiments 1-5, interesting node information stored in the interesting nodes list 21a managed by the manager nodes 2 includes information about receivers 2 recording broadcast contents and information about receivers 2 which have recorded broadcast contents and which have completed corrections of errors. Other information such as information about the receivers 2 which have recorded broadcast contents but have not completed error corrections may be stored in the interesting nodes list 21a. The interesting node information may be IP addresses and port numbers of the interesting nodes 2. With respect to the receivers 2 that have not yet completed corrections of errors in broadcast contents, information indicating the locations of the errors may be stored in the interesting nodes list 21a. Consequently, when the receivers 2 record broadcast contents containing errors, if the locations of the errors are different among the receivers 2, correct information may be exchanged among the receivers 2.

### EMBODIMENT 6

A broadcast system associated with Embodiment 6 is described below. The broadcast system of Embodiment 6 may be realized by a configuration similar to the broadcast system of the above-described Embodiment 1 and so like components are indicated by like reference numerals. Components which have been already described will not be described below.

In the broadcast device 1 of each of the above-described Embodiments 1-5, broadcast contents are multiplexed with information about manager nodes 2 assigned to the broadcast contents, and are then broadcast. The broadcast device 1 of Embodiment 6 also multiplexes information about the manager nodes 2 assigned to broadcast contents of the same series of broadcast contents or to related broadcast contents along with information about manager nodes 2 assigned to the specific broadcast contents.

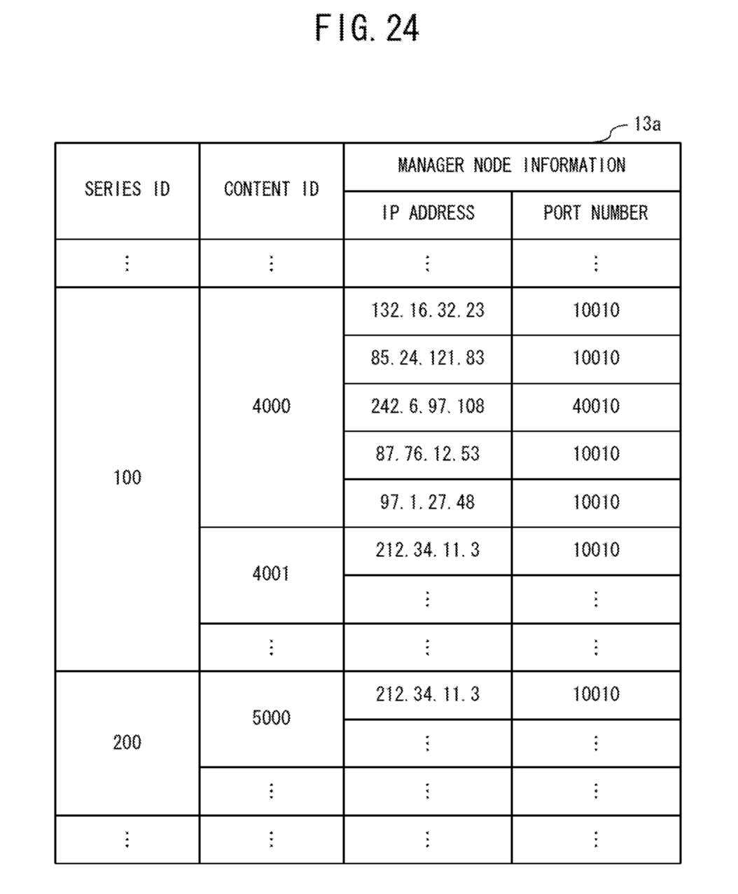

FIG. 24 is a schematic diagram illustrating the storage details of a manager node information table 13a according to Embodiment 6. The manager node information table 13a stored in the storage portion 13 of the broadcast device 1 of Embodiment 6 is a manager node information table illustrated in FIG. 24. As illustrated in FIG. 24, content ID and manager node information for specific broadcast contents are stored in the manager node information table 13a of the present embodiment (Embodiment 6). In addition, series IDs are stored. The series IDs are given to a series of broadcast contents broadcast in a given order or to related or similar broadcast contents, and provide information for identifying each series of broadcast contents.

If the broadcast multiplexing portion 102 of Embodiment 6 determines, based on the storage details of the broadcast information table 13c, that there are specific broadcast contents to be broadcast, then the broadcast multiplexing portion 102 reads the content ID of the specific broadcast contents from the broadcast information table 13c. The broadcast multiplexing portion 102 reads manager node information corresponding to the content ID read from the broadcast information table 13c from the manager node information table 13a. At this time, the broadcast multiplexing portion 102 of the present embodiment reads all the content IDs having the same series ID as the content ID read from the broadcast information table 13c, as well as manager node information, from the manager node information table 13a.

The broadcast multiplexing portion 102 reads out the broadcast contents corresponding to the content ID read out from the broadcast information table 13c, from the content database 13b. The broadcast multiplexing portion 102 creates broadcast data by multiplexing the broadcast contents read out from the content database 13b with the manager node information and with content ID read out from the manager node information table 13a. The broadcast multiplexing portion 102 distributes the created broadcast data via the broadcast delivery portion 14.

Consequently, the broadcast device 1 of Embodiment 6 broadcasts the manager node information about the broadcast contents. At the same time, the broadcast device 1 broadcasts manager node information about the broadcast contents of the same series as the first-mentioned broadcast contents or manager node information about related or similar broadcast contents. In consequence, a notice of manager node information about broadcast contents that the user who has already recorded the broadcast contents is highly likely to record is given in advance. This makes it unnecessary to search for manager nodes for broadcast contents of the same series as the already recorded broadcast contents or for manager nodes for related or similar broadcast contents. Accordingly, the communication load is further reduced.

In the broadcast system of Embodiment 6, the processing performed by the broadcast device 1 to assign manager nodes to broadcast contents is the same as the processing of the above-described Embodiment 1 already described in connection with FIG. 10 and so description is omitted. Furthermore, the processing performed by the broadcast device 1 of Embodiment 6 to broadcast contents is the same as the processing of the above-described processing of Embodiment 1 already described in connection with FIG. 11 and so description is omitted. The control portion 10 of the broadcast device 1 of Embodiment 6 reads all the manager node information of the same series ID as the content IDs read out from the broadcast information table 13c (step S12) from the manager node information table 13a (step S13 of FIG. 11).

In the broadcast system of Embodiment 6, the processing performed by the receiver 2 receiving broadcast data in which broadcast contents are multiplexed with manager node information to record is the same as the processing of the above-described Embodiment 1 already described in connection with FIGS. 12 and 13 and so description is omitted.

While the present embodiment (Embodiment 6) has been described as a modification of Embodiment 1 described above, Embodiment 6 may also be applied to the configurations of Embodiments 2-5 described previously.

### EMBODIMENT 7

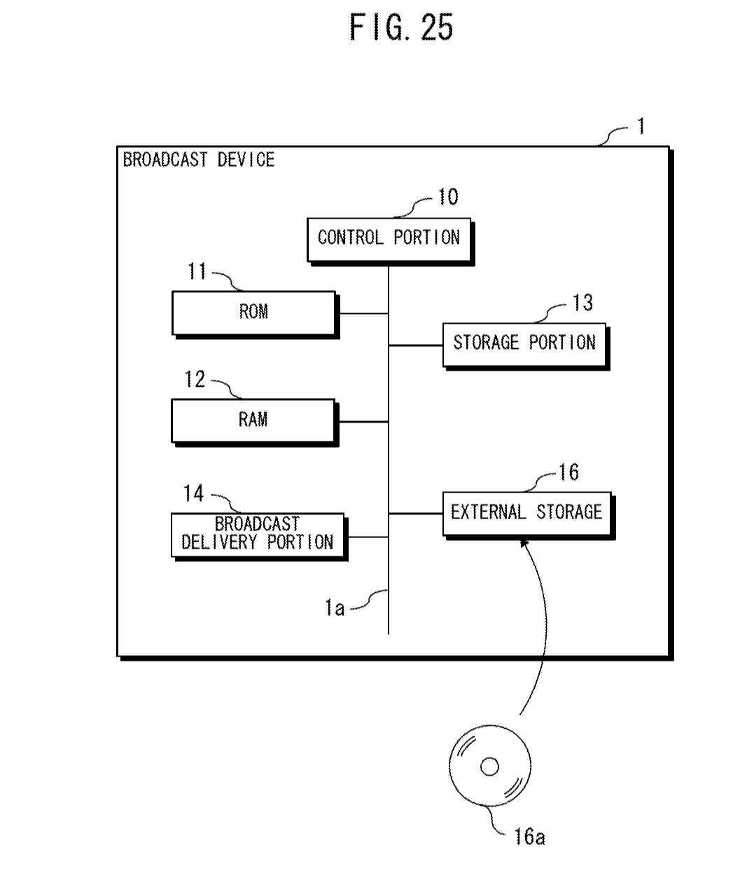

A broadcast system associated with Embodiment 7 is described below. FIG. 25 is a block diagram illustrating an example of configuration of a broadcast device 1 according to Embodiment 7. Each receiver 2 of Embodiment 7 is similar in configuration with the receiver 2 of Embodiment 1 described previously.

The broadcast device 1 of Embodiment 7 has an external storage 16 in addition to various hardware portions illustrated in FIG. 2. The external storage 16 includes, for example, a CD-ROM drive or DVD drive and reads data from a recording medium 16a that may be a CD-ROM or DVD-ROM.

The recording medium 16a records control programs to operate the broadcast device 1 described in the above embodiments. The external storage 16 reads the control programs from the recording medium 16a and stores the control programs in the storage portion 13. The control portion 10 reads the control programs stored in the storage portion 13 into the RAM 12 and executes the programs in turn. Thus, the broadcast device 1 of Embodiment 7 operates similarly to the broadcast device 1 described in the above embodiments.

The recording medium 16a may be a CD-ROM or a DVD-ROM. In addition, any other recording medium such as a flexible disk, memory card, or USB (universal serial bus) memory may also be used.

The broadcast device 1 may have a communication portion for connection with a network such as the Internet or a LAN (local area network). In this case, the broadcast device 1 may download a control program to operate the broadcast device 1 described in the above embodiments via the network and store the control program in the storage portion 13.

### EMBODIMENT 8

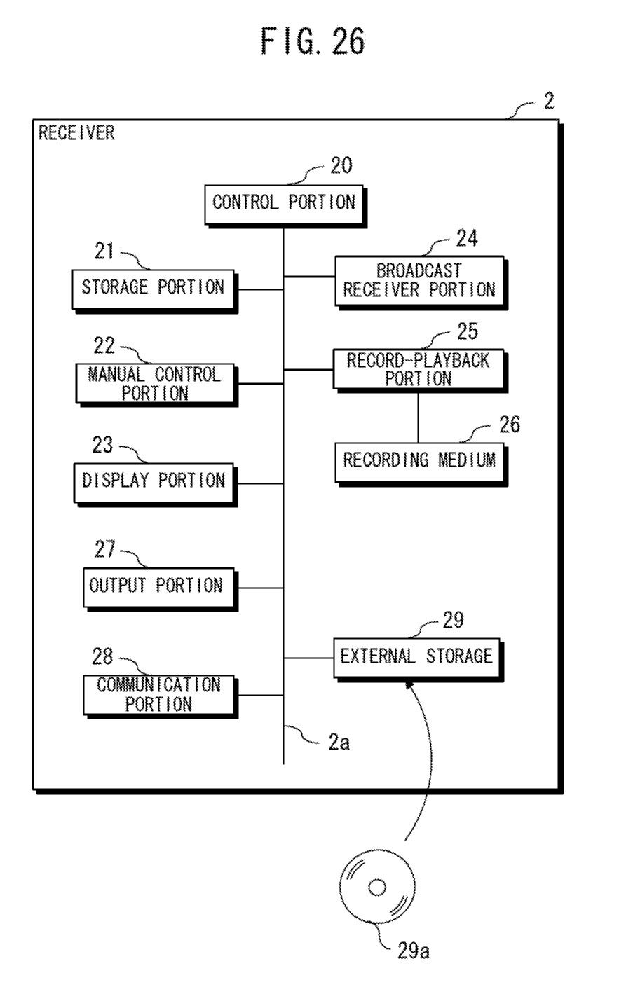

A broadcast system associated with Embodiment 8 is described below. FIG. 26 is a block diagram illustrating an example of configuration of a receiver 2 according to Embodiment 8. The broadcast device 1 of Embodiment 8 is similar in configuration with the broadcast device 1 of the above-described Embodiment 1.

The receiver 2 of Embodiment 8 has an external storage 29 in addition to the various hardware portions illustrated in FIG. 4. The external storage 29 may be a CD-ROM drive or DVD drive, for example, and reads data from a recording medium 29a such as a CD-ROM or DVD-ROM.

The recording medium 29a records control programs to operate the receiver 2 already described in the above embodiments. The external storage 29 reads the control programs from the recording medium 29a and stores the control programs in the storage portion 21. The control portion 20 executes the control programs stored in the storage portion 21. Consequently, the receiver 2 of Embodiment 8 operates similarly to the receiver 2 described in the above embodiments.

The recording medium 29a may be a CD-ROM or DVD-ROM. In addition, any other recording medium such as a flexible disk, memory card, or USB memory may also be used.

The receiver 2 may download a control program to operate the control program as the receiver 2 described in the above embodiments via the network N with which the communication portion 28 is connected and may store the control program in the storage portion 21.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A broadcast device comprising:
a specification unit that specifies an information holding device which holds recorder information for identifying recorders that receives and records broadcast contents;
an addition unit that attaches device information for identifying the information holding device specified by the specification unit, to the broadcast contents; and
a broadcast unit that broadcasts the broadcast contents to which the device information is attached by the addition unit.

2. The broadcast device according to claim 1, the device further comprising:
a communication unit for performing communications with an external device via a network;
a requesting unit for making a request to the external device via the communication unit for device information about the information holding device which holds recorder information for identifying recorders that receives and records broadcast contents; and
an acquisition unit for acquiring the device information about the information holding device which is sent back by the external device in response to the request from the requesting unit via the communication unit,
wherein, the specification unit specifies the information holding device corresponding to the broadcast contents based on the device information acquired by the acquisition unit.

3. The broadcast device according to claim 2, wherein the requesting unit makes the request for the device information about the information holding device corresponding to the broadcast contents at a time complying with a contents broadcast starting time.

4. The broadcast device according to claim 1, wherein the addition unit multiplexes the device information for identifying the information holding devices specified by the specification unit with the broadcast contents.

5. A receiver that receives broadcast contents from a broadcast device which broadcasts the broadcast contents, the receiver comprising:
a receiving unit that receives, from the broadcast device, device information for identifying an information holding device which holds recorder information for identifying recorders that receive and record the broadcast contents, and receive the broadcast contents from the broadcast device;
a recording unit that records the broadcast contents received by the receiving unit on a recording medium;
a determination unit that determines whether the broadcast contents recorded on the recording medium by the recording unit contain an error or not;
an acquisition unit that, when the determination unit determines that there is an error in the broadcast contents, acquires recorder information for identifying the recorder which records the same broadcast contents as the broadcast contents determined to contain an error by the determination unit, from the information holding device identified by the device information which is received by the receiving unit;
a contents acquisition unit that acquires the broadcast contents from the recorder identified by the recorder information acquired by the acquisition unit; and
a contents updating unit that updates the broadcast contents recorded on the recording medium by the recording unit, based on the broadcast contents acquired by the contents acquisition unit.

6. The receiver according to claim 5,
wherein, if the determination unit determines that there is an error in the broadcast contents recorded on the recording medium, identifies a location of the error,
wherein the contents acquisition unit acquires error location information about the location of the error identified by the determination unit from the recorder identified by the recorder information acquired by the acquisition unit, and
wherein the contents updating unit updates the broadcast contents recorded on the recording medium at the location of the error, based on the error location information acquired by the contents acquisition unit.

7. A receiver according to claim 5, wherein the determination unit determines whether contents recorded on the recording medium contains an error when a given amount of data received by the reception unit is recorded on the recording medium by the recording unit, and wherein the contents acquisition unit acquires data determined to contain an error by the determination unit from the recorder identified by the recorder information acquired by the acquisition unit.

8. A receiver according to claim 5, wherein there is further provided a selection unit for selecting an information holding device complying with given conditions from a plurality of information holding devices identified by the device information received by the reception unit, and wherein the acquisition unit acquires recorder information for identifying the recorder recording the broadcast contents from the information holding device selected by the selection unit, when the determination unit has determined that there is an error in the broadcast contents.

9. A receiver according to claim 8, wherein the selection unit selects the information holding device based on identification information for identifying each of the information holding devices.

10. A computer-readable storage medium storing a program, the program causing a computer to execute:
specifying an information holding device which holds recorder information for identifying recorders that receive and record broadcast contents; and
attaching, to the broadcast contents, device information for identifying the specified information holding device.

11. A computer-readable storage medium storing a program for receiving broadcast contents from a broadcast device that broadcasts the broadcast contents, the program causing a computer to execute:
receiving, from the broadcast device, device information for identifying an information holding device which holds recorder information for identifying a recorder that receives and records the contents, and receiving the broadcast contents from the broadcast device;
determining whether the received broadcast contents contain errors or not;
acquiring, when the determining determines that there are errors, recorder information for identifying the recorder which records the same broadcast contents as the broadcast contents determined to contain the errors, from the information holding device identified by the received device information;
acquiring the broadcast contents from the recorder identified by the acquired recorder information; and
updating the broadcast contents recorded on the recording medium based on the broadcast contents acquired from the recorder.

12. A broadcast method comprising:
specifying an information holding device which holds recorder information for identifying a recorder that receives and records broadcast contents;
attaching device information for identifying the information holding device specified by the specifying, to the broadcast contents; and
broadcasting the broadcast contents to which the device information is attached.
